(19) United States
(12) Patent Application Publication
(10) Pub. No.: US 2026/0339175 A1
(43) Pub. Date: Oct. 29, 2026

(54) ACCESSORY MOUNT AND ACCESSORY

(71) Applicant: CANON KABUSHIKI KAISHA, Tokyo (JP)

(72) Inventor: MASATO SHIMIZU, Tochigi (JP)

(21) Appl. No.: 19/648,029

(22) Filed: Apr. 15, 2026

(30) Foreign Application Priority Data
Apr. 28, 2025 (JP) 2025-074299

(51) Int. Cl. G03B 17/14; G03B 17/56

(52) U.S. Cl. CPC G03B 17/14; G03B 17/566

(57) ABSTRACT

An accessory mount may be attachable to and detachable from a camera mount that includes a first terminal portion. The accessory mount may include a second terminal portion configured to contact the first terminal portion while the accessory mount is attached to the camera mount, and a terminal holder that holds the second terminal portion. The terminal holder may include a first step and a second step having different heights in a central axis direction. The second terminal portion may include a first terminal, a second terminal, and a third terminal that have different tip heights in the central axis direction. The first terminal may be configured to be used to detect that the accessory mount is attached to the camera mount.

### BACKGROUND

### Field of the Technology

The present disclosure relates to an accessory mount and an accessory.

### Description of the Related Art

Japanese Patent Application Laid-Open No. 2018-205733 discloses an accessory apparatus that is attachable to and detachable from an image pickup apparatus.

### SUMMARY

An accessory mount according to one aspect of the present disclosure may be attachable to and detachable from a camera mount that includes a first terminal portion. The accessory mount may include a second terminal portion configured to contact the first terminal portion while the accessory mount is attached to the camera mount, and a terminal holder that holds the second terminal portion. The terminal holder may include a first step and a second step having different heights in a central axis direction. The second terminal portion may include a first terminal, a second terminal, and a third terminal that have different tip heights in the central axis direction. The first terminal may be configured to be used to detect that the accessory mount is attached to the camera mount. An accessory having the above accessory mount also constitutes another aspect of the present disclosure.

Features of the present disclosure will become apparent from the following description of embodiments with reference to the attached drawings. The following description of embodiments will be described by way of example.

### BRIEF DESCRIPTION OF THE DRAWINGS

FIG. 1 is a diagram illustrating a relationship among an image pickup apparatus, a lens apparatus, and an intermediate accessory apparatus according to the present embodiment.

FIG. 2 is a block diagram of the image pickup apparatus and the lens apparatus according to the present embodiment.

FIG. 3 is a block diagram of the image pickup apparatus and the lens apparatus according to the present embodiment.

FIGS. 4A and 4B are schematic diagrams of a mount portion according to the present embodiment.

FIGS. 5A, 5B, and 5C are diagrams illustrating connection states between respective terminals caused by relative rotation between a camera mount A and a lens mount B according to the present embodiment.

FIG. 6 is a block diagram of the image pickup apparatus, a conversion adapter, and the lens apparatus according to the present embodiment.

FIGS. 7A and 7B are explanatory diagrams of the mount portion according to the present embodiment.

FIG. 8 is a block diagram of the image pickup apparatus, the conversion adapter, and the lens apparatus according to the present embodiment.

FIG. 9 is a block diagram of the image pickup apparatus, an intermediate accessory, and the lens apparatus according to the present embodiment.

FIG. 10 is a block diagram of the image pickup apparatus, the intermediate accessory, and the lens apparatus according to the present embodiment.

FIGS. 11A, 11B, 11C, 11D, and 11E are schematic diagrams of peripheral circuits of a TYPE terminal according to the present embodiment.

FIG. 12 is a flowchart illustrating communication selection processing according to the present embodiment.

FIG. 13 is a flowchart illustrating second communication according to the present embodiment.

FIG. 14 is a diagram illustrating broadcast communication of third communication according to the present embodiment.

FIG. 15 is a diagram illustrating P2P communication of third communication according to the present embodiment.

FIGS. 16A and 16B are internal configuration diagrams of respective terminals in each of a comparative example and the present embodiment.

FIGS. 17A, 17B, 17C, and 17D are diagrams illustrating effects on an electric circuit according to differences in terminals disposed adjacent to an LCLK terminal according to the present embodiment.

FIG. 18 is an explanatory diagram of an internal configuration of a camera mount A of a camera body according to the present embodiment.

FIG. 19 is an exploded perspective view illustrating an example of the mount portion according to the present embodiment.

### DESCRIPTION OF THE EMBODIMENTS

Referring now to the accompanying drawings, a detailed description will be given of embodiments according to the present disclosure.

First, prior to a description of the present embodiment, a variety of terms used in the present disclosure will be described. An accessory apparatus (accessory) refers to an apparatus that is attachable to and detachable from an image pickup apparatus (camera body). The image pickup apparatus and the accessory apparatus are attached by coupling a mount portion (camera mount, first mount portion) of the image pickup apparatus with a mount portion (accessory mount, second mount portion) of the accessory apparatus. The accessory apparatus (mount apparatus) includes a lens apparatus having an imaging optical system. The accessory apparatus (mount apparatus) also includes a conversion adapter or an intermediate accessory apparatus that is attached (or mounted) between the lens apparatus and the image pickup apparatus. A mount portion is a coupling portion provided in each of the image pickup apparatus and the accessory apparatus. Electrical contacts are provided in the mount portion of the image pickup apparatus and in the mount portion of the accessory apparatus, respectively. In a case where the accessory apparatus is attached to the image pickup apparatus, the electrical contacts provided in the respective mount portions (camera mount and accessory mount) come into contact with each other. That is, the mount portion has not only a function of mechanically coupling the image pickup apparatus and the accessory apparatus, but also a function of electrically connecting the image pickup apparatus and the accessory apparatus. An apparatus having the camera mount is not limited to the image pickup apparatus, and may be an apparatus for performing firmware updates of a lens by connection to a PC, a measurement apparatus, or an adapter, extender, extension tube, or the like.

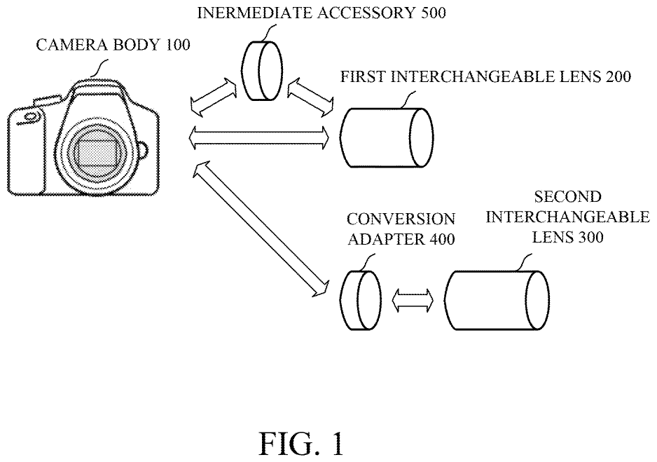

Next, with reference to FIG. 1, a description will be given of a relationship among an image pickup apparatus, a lens apparatus, and an intermediate accessory apparatus that constitute an imaging system according to the present embodiment. FIG. 1 illustrates the relationship among a camera body (image pickup apparatus) 100, a first interchangeable lens (lens apparatus) 200, a second interchangeable lens (lens apparatus) 300, a conversion adapter 400, and an intermediate accessory 500. The apparatuses indicated by arrows in FIG. 1 can be attached to each other by coupling their respective mount portions. The camera body 100 includes an image sensor such as a CMOS sensor or a CCD sensor. An object can be captured by attaching the first interchangeable lens 200 or the second interchangeable lens 300 to the camera body 100.

The mount portion (accessory mount) of the accessory apparatus includes a plurality of accessory concave portions (accessory recesses) and accessory claws that are engageable with a plurality of camera claws and camera concave portions (camera recesses) arranged in order in a circumferential direction approximately orthogonal to an optical axis in the camera mount. The accessory mount is movable from a fitted state, in which the claws and concave portions of the respective mounts are fitted to each other, to an engaged state, in which the claws are engaged with each other in a direction parallel to the optical axis (simply referred to as an optical axis direction hereinafter). The fitted state corresponds to an attachment start state of the accessory apparatus described later, and the engaged state corresponds to an attachment completion state of the accessory apparatus described later.

With reference to FIG. 1, accessory apparatuses connectable to the camera body 100 will be described. The first interchangeable lens 200 is one of the accessories that is directly attachable to the camera body 100, and includes a lens mount B serving as an accessory mount that can be directly coupled to a camera mount (described later) of the camera body 100. The intermediate accessory 500 is also one of the accessories that is directly attachable to the camera body 100, and includes a lens mount B serving as an accessory mount that can be directly coupled to the camera body 100, and a camera mount A that can be directly coupled to the first interchangeable lens 200. That is, the first interchangeable lens 200 can also be connected to the camera body 100 via the intermediate accessory 500.

The second interchangeable lens 300 can be indirectly attached to the camera body 100 via a conversion adapter 400 that is directly attachable to the camera body 100. That is, a lens mount D, which is an accessory mount provided in the second interchangeable lens 300, cannot be directly coupled to the camera mount A provided in the camera body 100. A camera mount C provided in the conversion adapter 400 and the lens mount D of the second interchangeable lens 300 can be directly coupled (attached) to each other.

As described above, the camera body 100 can be attached to the first interchangeable lens 200, the first interchangeable lens 200 via the intermediate accessory 500, or the second interchangeable lens 300 via the conversion adapter 400. In the following description, matters common to the first interchangeable lens 200 and the second interchangeable lens 300 will be described by collectively referring to them as an interchangeable lens. Similarly, the conversion adapter 400 and the intermediate accessory 500 will be collectively referred to as an adapter.

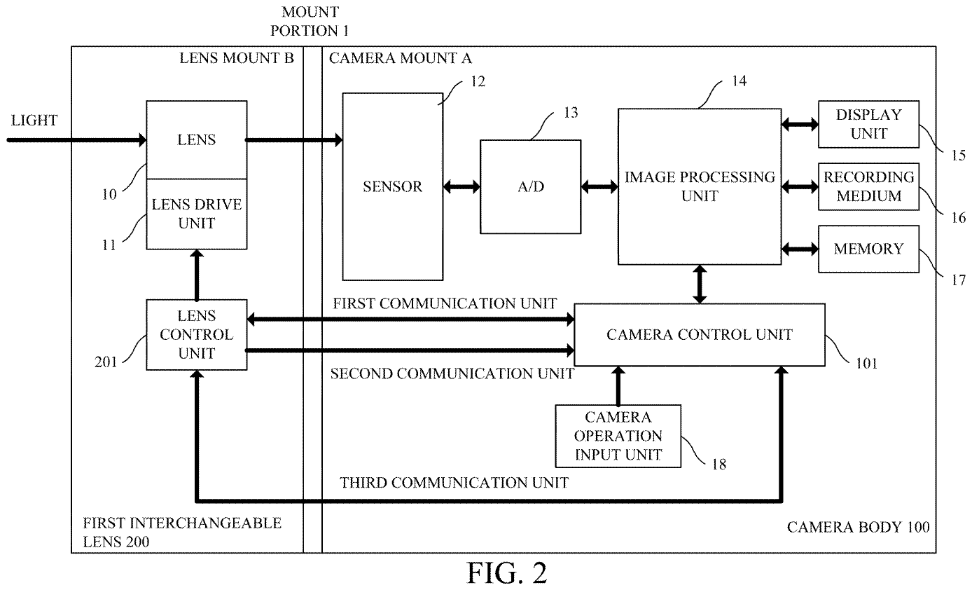

Next, with reference to FIG. 2, the basic configurations of the camera body 100 and the first interchangeable lens 200 will be described. FIG. 2 is a block diagram illustrating an imaging system including the first interchangeable lens 200 and the camera body 100 to which the first interchangeable lens 200 can be directly coupled (attached and detached). In FIG. 2, the respective mounts provided in the first interchangeable lens 200 and the camera body 100 are collectively referred to as a mount portion 1. Details of the respective mounts will be described later. In the present embodiment, the image pickup apparatus (e.g., the camera body 100) and the accessory (e.g., the first interchangeable lens 200) are attachable to and detachable from each other.

The camera body 100 is an image pickup apparatus represented by a digital camera. As illustrated in FIG. 2, the camera body 100 includes a charge-accumulation-type imaging sensor (image pickup element) 12 that photoelectrically converts an optical image of an object guided by a lens 10 provided inside the first interchangeable lens 200 and outputs an electrical signal. The camera body 100 further includes an A/D converter 13 that converts an analog electrical signal output from the image sensor 12 into a digital signal, and an image processing unit 14 that generates a video signal by performing various types of image processing on the digital signal. The video signal (still or moving images) generated by the image processing unit 14 can be displayed on a display unit 15 and recorded on a recording medium 16.

The camera body 100 further includes a memory 17 that functions as a buffer when processing the video signal and stores an operation program used by a camera control unit 101 described later. The camera body 100 further includes a camera operation input unit 18 including a power switch for turning the power on and off, an imaging switch (release switch) for starting recording of a video signal, and selecting/setting switches for setting a variety of menus. The camera body 100 further includes a camera control unit 101 including a microprocessor (CPU) that comprehensively controls operations of the camera body 100 and accessories attachable to the camera body 100. The camera control unit 101, for example, performs a variety of settings based on signals input from the camera operation input unit 18, or controls communication with a lens control unit 201 provided in the first interchangeable lens 200 via the mount portion 1.

On the other hand, the first interchangeable lens 200 includes the lens 10, which is an optical member including a plurality of lens units such as a zoom lens, a shift lens, and a focus lens, and a light amount adjustment member such as an aperture stop (diaphragm). The first interchangeable lens 200 further includes a lens drive unit 11 that includes actuators for moving or operating optical members, such as the plurality of lens units or the aperture stop and drives the actuators. The first interchangeable lens 200 further includes the lens control unit 201 including a microprocessor (LCPU) for the lens that comprehensively controls operations of the first interchangeable lens 200. The lens control unit 201 controls, for example, communication with the camera control unit 101 via the mount portion 1 and controls the lens drive unit 11.

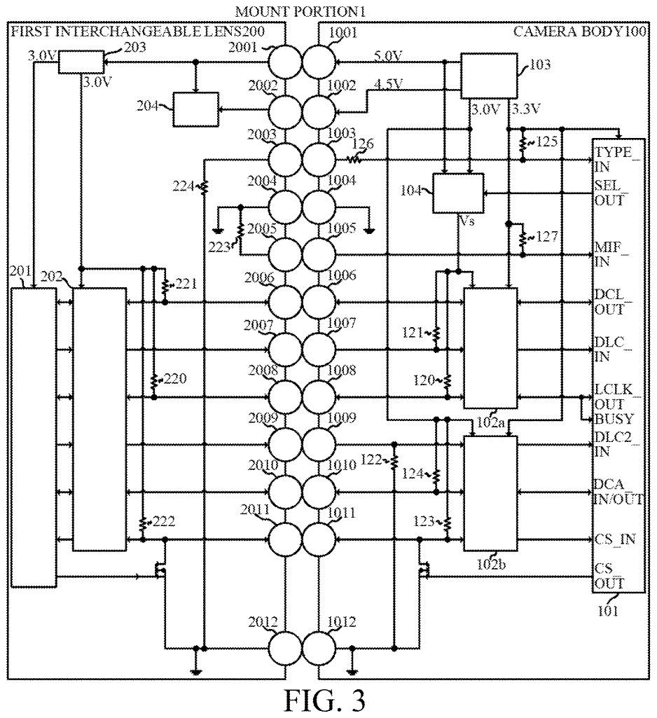

Next, with reference to FIG. 3, the internal configurations of the camera body 100 and the first interchangeable lens 200 in a connected state between the camera body 100 and the first interchangeable lens 200 will be described. FIG. 3 is a block diagram illustrating the internal configurations of the camera body 100 and the first interchangeable lens 200 while they are connected to each other. The camera mount and the lens mount include a lock mechanism, a mount holding mechanism, and a plurality of electrical terminals. Details of the respective mounts will be described later.

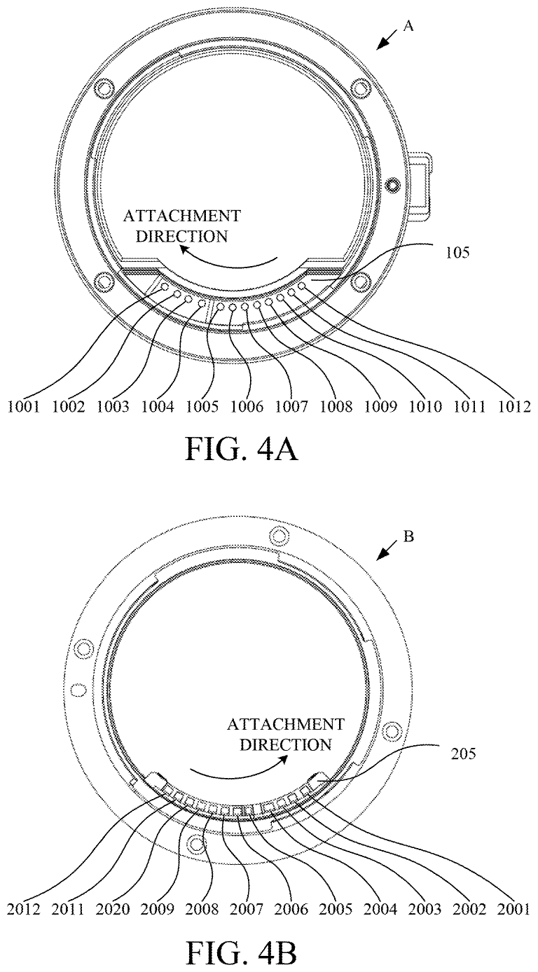

As illustrated in FIG. 3, the mount portion 1 includes a plurality of terminals that electrically connect the camera body 100 and the first interchangeable lens 200. In the camera body 100, the plurality of terminals (camera-side terminals) are exposed to the outside of the camera body 100 as a plurality of electrical contact pins provided in a contact holding member (terminal holder) 105 of the ring-shaped camera mount A (see FIG. 4A). In the first interchangeable lens 200, the plurality of terminals (accessory-side terminals) are exposed to the outside of the first interchangeable lens 200 as a plurality of electrical contact surfaces provided in a contact surface holding member (terminal holder) 205 of the ring-shaped lens mount B (see FIG. 4B). While the first interchangeable lens 200 is attached to the camera body 100, corresponding electrical contact pins and electrical contact surfaces are electrically connected to each other.

In the present embodiment, each mount includes steps having different heights in the optical axis direction (a central axis direction of the mount) such that contact positions of corresponding terminals in the optical axis direction differ from each other, as described later. The plurality of terminals are unitized as a single component, and in each mount the terminals are connected as a single wiring portion to a flexible printed circuit (board) (FPC).

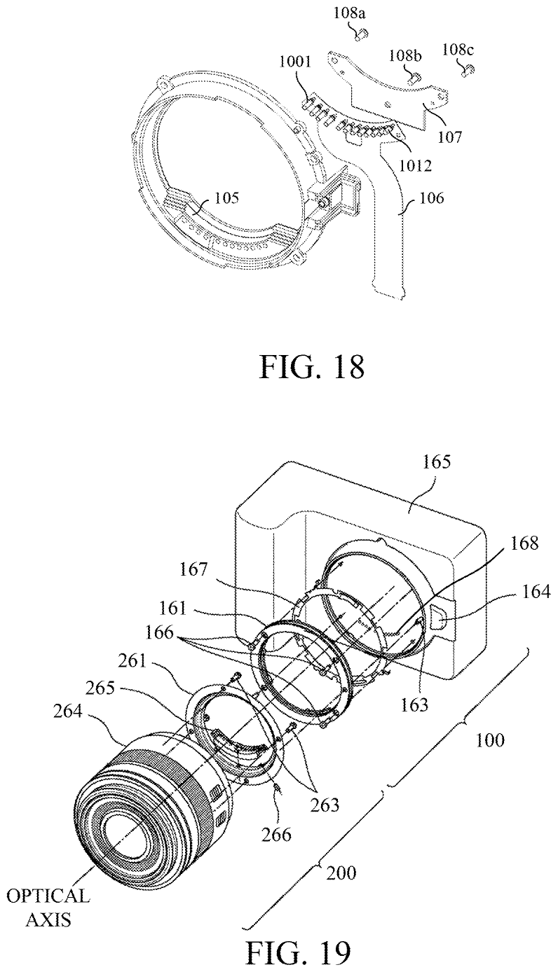

FIG. 18 illustrates the internal configuration of the camera mount A of the camera body 100 in the present embodiment. As illustrated in FIG. 18, for example, the terminals are electrically connected by a single FPC 106 and are connected to an internal substrate (not illustrated) provided inside the camera body 100. A plurality of holes into which the respective terminals can be inserted are provided at positions of the contact holding member 105 where the respective terminals are held, and terminals (electrical contacts) 1001 to 1012 as camera-side terminals are inserted into the respective holes. In this state, a pressing plate 107 presses the terminals toward the object side in the optical axis direction (mount contact surface side), and screws 108a, 108b, and 108c are fastened to the contact holding member 105 while inserted into the through-holes in the pressing plate 107.

While the present embodiment has discussed a single-unit structure of the camera mount A in the camera body 100, other mounts described later are also common at least in that a plurality of terminals are electrically connected to a single FPC (wiring).

In a case where this configuration is compared with a case where terminal groups of each mount are divided into a plurality of units and arranged in the circumferential direction of the mount, for example, the terminals can be collectively arranged at a position away from an exposure opening provided in front of the image sensor 12. Therefore, for example, in a case where unnecessary light enters the camera mount side while an accessory is attached to the camera body 100, it is possible to suppress the influence of the unnecessary light reflected by terminals formed of metal members on capturing of an object. Forming the terminals as a single unit can reduce complexity of wiring inside the image pickup apparatus and the accessory while facilitating assembly during mount assembly.

Functions of respective terminals common to the camera mount A and the lens mount B will now be described.

VDD terminals 1001 and 2001 are terminals (electrical contacts) used to supply, from the camera body 100 to the accessory (e.g., the first interchangeable lens 200), communication control power (VDD) serving as communication power mainly used for communication control. The voltage supplied to the first interchangeable lens 200 is 5.0 V.

VBAT terminals 1002 and 2002 are terminals used to supply, from the camera side to the accessory side, driving power (VBAT) serving as drive power used for the operation of a mechanical drive unit of an actuator used to drive the aperture stop or the focus lens. In other words, the VBAT terminals 1002 and 2002 are terminals used to supply power other than the communication power. The voltage of the power supplied to the first interchangeable lens 200 is 4.5 V. The VDD terminals and the VBAT terminals described above are power supply terminals for supplying power from the camera body 100 to the accessory. The voltage supplied to the VBAT terminal may be changeable by changing an output setting of the power supply circuit in accordance with a type of accessory attached to the camera body 100.

DGND terminals 1012 and 2012 are ground terminals corresponding to the communication control power supply VDD. That is, the DGND terminals 1012 and 2012 indicate a ground level (voltage) corresponding to predetermined terminals. In the present embodiment, grounding means setting a voltage level of a ground terminal to approximately the same level (ground level) as that of a negative side of a power supply such as a battery.

PGND terminals 1004 and 2004 are terminals used to indicate a ground level corresponding to mechanical drive terminals including a motor (actuator) provided in the camera body 100 and the accessory (e.g., the first interchangeable lens 200). That is, the PGND terminals are ground terminals corresponding to the drive power supply VBAT. The DGND terminals and the PGND terminals described above are ground terminals for grounding various power supply systems of the camera body 100 and the accessory to the ground level.

MIF terminals 1005 and 2005 are terminals used to detect that an accessory (e.g., the first interchangeable lens 200) is attached to the camera body 100. The camera control unit 101 detects that the accessory is attached to or detached from the camera body 100 by detecting a voltage level indicated by the MIF terminal. In the present embodiment, the camera control unit 101 determines that the accessory is attached to the camera body 100 based on a change of a voltage value indicated by the MIF terminal to approximately 0 V. Based on this detection, the camera control unit 101 controls, for example, to start power supply to the power supply terminals and to start communication between the camera body 100 and the accessory after detecting the attachment of the accessory.

TYPE terminals 1003 and 2003 are terminals used to determine the type of accessory (e.g., the first interchangeable lens 200) attached to the camera body 100. The camera control unit 101 detects a voltage value of a signal indicated by the TYPE terminal and determines the type of accessory attached to the camera body 100 based on the value. In the first interchangeable lens 200, the TYPE terminal is pull-down connected to the DGND terminal with a predetermined resistance value described later. The resistance value differs according to the type of accessory.

Next, a variety of communication terminals between the camera body 100 and the accessory will be described. The plurality of communication terminals provided in the mount portion 1 are divided into a plurality of communication systems (groups), and each communication system can perform communication independently. In the present embodiment, LCLK terminals 1008 and 2008, DCL terminals 1006 and 2006, and DLC terminals 1007 and 2007 constitute a first communication unit that performs first communication. DLC2 terminals 1009 and 2009 constitute a second communication unit that performs second communication independently of the first communication unit. CS terminals 1011 and 2011 and DCA terminals 1010 and 2010 constitute a third communication unit that performs third communication independently of the first and second communication units. In the present embodiment, the camera control unit 101 and the lens control unit 201 can perform first to third independent communications via the plurality of communication terminals described above.

The LCLK terminals 1008 and 2008 are terminals for the first communication unit, and are used (i) to output a communication clock signal from the camera body 100 to the accessory, and (ii) to allow the camera body 100 to monitor a busy state of the accessory.

The DCL terminals 1006 and 2006 are terminals for the first communication unit, and are used to communicate data for performing bidirectional communication between the camera body 100 and the accessory.

The DLC terminals 1007 and 2007 are terminals for the first communication unit, and are used to communicate data output from the accessory (e.g., the first interchangeable lens 200) to the camera body 100.

The LCLK terminals, DCL terminals, and DLC terminals corresponding to the first communication unit described above can switch a signal output method between a so-called CMOS output type and an open type. The CMOS output type in the present embodiment has switch outputs for both H (high) and L (low) voltage levels. In contrast, the open type has a switch output only on the L side. The open type in the present embodiment indicates a so-called open-drain type, but may be an open-collector type.

The DLC2 terminals 1009 and 2009 are terminals for the second communication unit, and include terminals for communication data output from the accessory (e.g., the first interchangeable lens 200) to the camera body 100.

The DCA terminals 1010 and 2010 are terminals for the third communication unit, and include terminals for communication data for performing bidirectional communication between the camera body 100 and the accessory (e.g., the first interchangeable lens 200).

The CS terminals 1011 and 2011 are terminals for the third communication unit, and include signal terminals for requesting communication between the camera body 100 and the accessory (e.g., the first interchangeable lens 200). In the present embodiment, in a case where the first interchangeable lens 200 is attached to the camera body 100, a communication voltage at the terminals corresponding to the first to third communication units is set to 3.0 V.

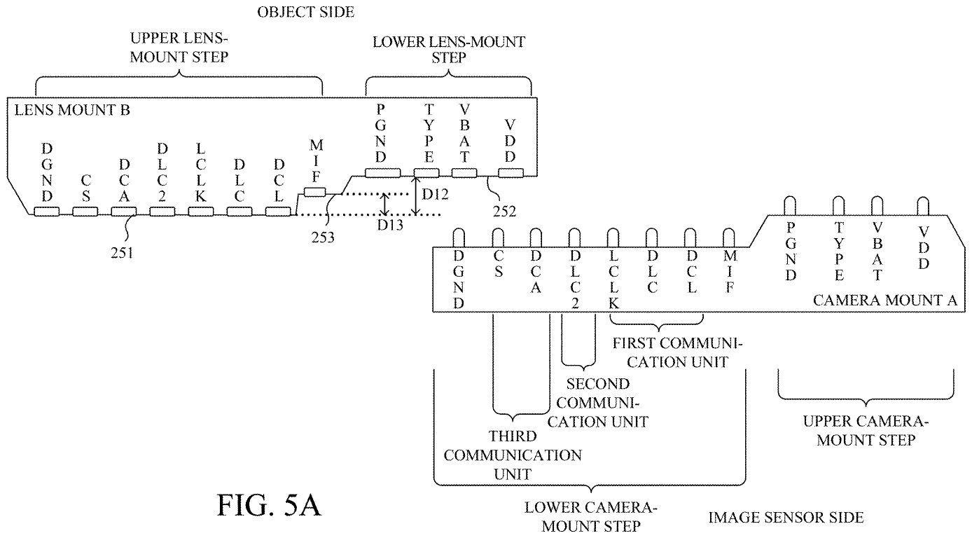

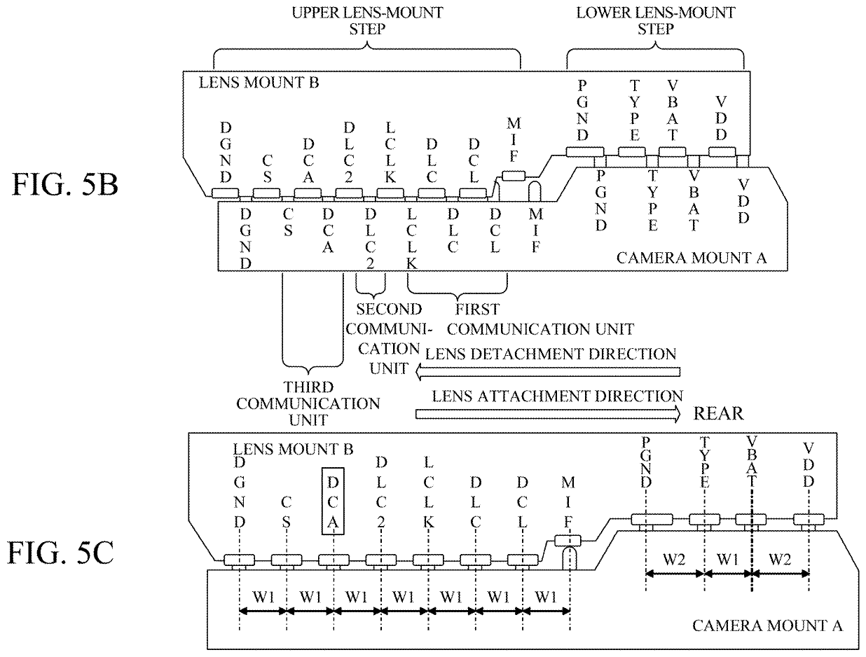

Next, with reference to FIGS. 4A, 4B, 5A, 5B, and 5C, a structure of the mount portion 1 including the camera mount A and the lens mount B will be described. FIGS. 4A and 4B are diagrams illustrating the configurations of the camera mount A and the lens mount B according to the present embodiment. FIG. 4A is a front view of the camera mount A provided in the camera body 100, and FIG. 4B is a front view of the lens mount B provided in the first interchangeable lens 200.

FIGS. 5A, 5B, and 5C are diagrams illustrating connection states between respective terminals caused by relative rotation between the camera mount A and the lens mount B in the present embodiment. FIG. 5A illustrates the attachment start state between the camera mount A and the lens mount B, FIG. 5B illustrates the attachment transition state between the camera mount A and the lens mount B, and FIG. 5C illustrates an attachment completion state between the camera mount A and the lens mount B. FIGS. 5A, 5B, and 5C illustrate states in which terminals provided in the respective mounts are viewed from a direction orthogonal to an optical axis of the camera mount A and the lens mount B. Here, the optical axis described above is parallel to the central axis passing through the center of the opening portion in the camera mount A and the lens mount B.

The state illustrated in FIG. 5A is a state in which a plurality of claws provided in the camera mount A are inserted into a plurality of concave portions provided in the lens mount B, and a plurality of claws provided in the lens mount B are inserted into a plurality of concave portions provided in the camera mount A. By relatively rotating the camera mount A and the lens mount B from this state in a lens attachment direction, the state transitions to a state in which corresponding terminals provided in both mounts are connected to each other, as illustrated in FIG. 5C. Here, the lens attachment direction is a direction orthogonal to a central axis of the camera mount A (and the lens mount B), and is an attachment direction of the interchangeable lens on the basis of the camera mount A side in the present embodiment. In a case where the optical axis (of the lens apparatus) coincides with a mount central axis, the lens attachment direction and the optical axis are orthogonal to each other. In the state illustrated in FIG. 5C, the relative rotation between the camera mount A and the lens mount B is restricted by a lock mechanism (not illustrated) serving as a rotation restricting member provided to each mount.

The state illustrated in FIG. 5B is a state in which only the PGND terminals start to be connected before other corresponding terminals during a period between the attachment start state and the attachment completion state between the camera mount A and the lens mount B described above. Details will be described later.

In the present embodiment, the electrical terminals provided in the camera mount will be referred to as contact pins, and electrical terminals provided in the lens mount will be referred to as contact surfaces (or contact pieces) in the following description. Alternatively, terminals provided in the camera mount may be contact surfaces and terminals provided in the lens mount may be contact pins.

As illustrated in FIGS. 4A, 4B, 5A, 5B, and 5C, the mount portion 1 according to the present embodiment has steps in an optical axis direction (the direction parallel to the central axis of the mount portion). The camera mount A is a two-step mount, and the lens mount B is a three-step mount. As illustrated in FIG. 5A, in the camera mount A of the camera body 100, a step protruding toward the object side is referred to as an upper camera-mount step (second step), and a step on an image sensor side will be referred to as a lower camera-mount step (first step). That is, the upper camera-mount step protrudes toward the object side (or accessory side) more than the lower camera-mount step in the optical axis direction.

As illustrated in FIG. 5A, in the lens mount B of the first interchangeable lens 200, a step recessed toward the object side will be referred to as a lower lens-mount step (second step 252), and a step protruding toward the image sensor side when attached to the camera mount will be referred to as an upper lens-mount step (first step 251). A step disposed between the upper step (first step 251) and the lower step (second step 252) in the optical axis direction will be referred to as a middle (or intermediate) lens-mount step (third step 253). That is, while the lens mount is attached to the camera mount, the upper lens-mount step protrudes toward the image pickup apparatus side more than the lower lens-mount step in the optical axis direction (central axis direction of the mount). Terminals on the upper camera-mount step can contact only terminals on the lower lens-mount step, and terminals on the lower camera-mount step can contact only terminals on the upper and middle lens-mount steps. In the camera mount A, the lower camera-mount step is located on a front side (near side) in a rotation direction relative to the lens mount B (accessory attachment direction), and the upper camera-mount step is located on a rear side (far side). In the lens mount B, the middle lens-mount step is located on the frontmost side in a rotation direction relative to the camera mount A, followed by the upper step, and the lower step is located on the rear side. The first step, the second step, and the third step correspond to surfaces of the terminal holder facing the camera mount.

The first step is located at a first height, the second step is located at a second height, and the third step is located at a third height. Here, “height” is intended to mean a height (in a global coordinate system) relative to a common reference. In other words, it does not mean that the height from the surface of each step differs (i.e., a height reference differs for each step). Thus, even if lengths (protrusion amounts from the surface of the terminal holder) of a plurality of terminals (e.g., the MIF terminal and the VDD terminal) are the same as each other, their heights are different. Four or more terminals may have different heights from each other.

The first height, the second height, and the third height may not have to be strictly equal heights, and may vary as long as they fall within a range in which contact with camera-side terminals can be made. That is, in place of step differences on the accessory side, terminals may have different lengths corresponding to step differences on the camera side.

However, the present embodiment is not limited to this example, and the lens mount B may have only two steps, i.e., the upper lens-mount step (first step 251) and the lower lens-mount step (second step 252). That is, in the present embodiment, the contact surface holding member 205 has the first step 251 and the second step 252 having mutually different heights in the optical axis direction. In the present embodiment, a second terminal portion includes a plurality of terminals including a first terminal (MIF terminal 2005), a second terminal (DCL terminal 2006), and a third terminal (PGND terminal 2004), whose tip heights differ from each other in the optical axis direction. The contact surface holding member 205 may have the third step 253.

In the present embodiment, a plurality of terminals including a DCL terminal (second terminal) may be arranged on the first step 251, a plurality of terminals including a PGND terminal (third terminal) may be arranged on the second step 252, and an MIF terminal (first terminal) may be disposed on the third step 253. In the present embodiment, only the MIF terminal is disposed on the third step 253, but the present embodiment is not limited to this example, and a terminal other than the MIF terminal may be disposed on the third step 253. Alternatively, only terminals other than the MIF terminal may be disposed on the third step 253.

Here, let D12 be a distance between the first step 251 and the second step 252 in the optical axis direction, and let D13 be a distance between the first step 251 and the third step 253. In this case, in the present embodiment, the following inequality (A) may be satisfied:

0.0<D13/D12<0.8 (A)

Inequality (A) may be replaced with the following inequality (A1):

0.1<D13/D12<0.7 (A1)

Inequality (A) may be replaced with the following inequality (A2):

0.2<D13/D12<0.6 (A2)

In the present embodiment, steps are provided in both the camera mount A and the lens mount B so as to make positions (in a direction parallel to the mount central axis) at which terminals for electrical connection are arranged different from each other. However, the present embodiment is not limited to this example, and steps may be provided only on the lens mount B side, or steps may be provided in each of the lens mount B and the camera mount A. Any configuration may be employed as long as it makes positions at which terminals are arranged different from each other in each mount. For example, the mount may have a tilted surface that continuously changes positions of terminals arranged in a direction parallel to the mount central axis, or may have a configuration in which protrusion amounts of the terminals themselves protruding in a direction parallel to the mount central axis differ from each other.

As illustrated in FIG. 5C, the lens mount B moves and rotates (rightward in the drawing) relative to the camera mount A while respective terminals provided on the lens mount B and the camera mount A slide and contact each other. For example, while the attachment of the camera body 100 and the first interchangeable lens 200 is completed, each contact pin of the camera mount A and a corresponding contact surface of the lens mount B are electrically connected independently. In the following, for simple description purposes, electrical conduction between a pair of corresponding terminals in the camera mount A and the lens mount B will be referred to as connection, and electrical conduction between terminals that are not paired (non-corresponding) will be referred to as contact.

In the present embodiment, a plurality of claw groups provided on the camera mount A side and the lens mount B side are bayonet claws, and the attachment (coupling) of the two is completed when the claw groups are engaged with each other in the optical axis direction by a so-called bayonet coupling method.

Next, the arrangement order of the terminals of the mount portion 1 according to the present embodiment will be described. In the present embodiment, a lens (accessory) attachment direction is a rotation (attachment) direction of the lens mount B relative to the camera mount A that is on the basis. Therefore, on the basis of the accessory attachment direction, among terminals provided in the camera mount A, a side on which a terminal (VDD terminal) that lastly contacts a terminal provided in the lens mount B is located is the rear side (far side) in the lens attachment direction, and the opposite side is the front side (near side). Among terminals provided in the lens mount B, a side on which a terminal (VDD terminal) that first contacts a terminal provided in the camera mount A is located is the rear side in the lens attachment direction, and the opposite side is the front side.

As illustrated in FIG. 5A, the VDD terminal 1001, the VBAT terminal 1002, the TYPE terminal 1003, and the PGND terminal 1004 are arranged in this order from the rear side (terminal end) in the lens attachment direction on the upper camera-mount step. Here, the rear side in the lens attachment direction is a side on which a terminal that lastly contacts a lens-side terminal is located when the first interchangeable lens 200 is attached to the camera body 100.

The MIF terminal 1005, the DCL terminal 1006, the DLC terminal 1007, the LCLK terminal 1008, the DLC2 terminal 1009, the DCA terminal 1010, the CS terminal 1011, and the DGND terminal 1012 are arranged in this order from the rear side in the lens attachment direction on the lower camera-mount step.

Similarly, the VDD terminal 2001, the VBAT terminal 2002, the TYPE terminal 2003, and the PGND terminal 2004 are arranged in this order from the rear side in the lens attachment direction on the lower lens-mount step. The MIF terminal 2005 is disposed on the middle lens-mount step. The DCL terminal 2006, the DLC terminal 2007, the LCLK terminal 2008, the DLC2 terminal 2009, the DCA terminal 2010, the CS terminal 2011, and the DGND terminal 2012 are arranged in this order from the rear side in the lens attachment direction on the upper lens-mount step.

That is, four terminals are arranged on each of the upper camera-mount step and the lower lens-mount step, eight terminals are arranged on the lower camera-mount step, seven terminals are arranged on the upper lens-mount step, and one terminal is disposed on the middle lens-mount step. Thus, the upper camera-mount step and the lower lens-mount step are configured to have fewer terminals (exposed contacts) than the total number of terminals on the lower camera-mount step and on the upper and middle lens-mount steps arranged to face the lower camera-mount step.

In a case where the attachment and detachment between the image pickup apparatus and the accessory are performed by rotating the camera mount and the lens mount relative to each other as in the bayonet coupling method, the terminals provided in the mounts slide against each other during the attachment and detachment. In general, on the same surface in the optical axis direction, on the camera-mount side, a contact pin located at the rearmost side in a lens attachment direction does not slide against a non-corresponding accessory-side contact surface during the attachment and detachment of the accessory to and from the image pickup apparatus. Also, on the same surface in the optical axis direction, on the lens-mount side, the contact surface located at the frontmost side in the lens attachment direction does not slide against the non-corresponding camera-side contact pin during the attachment and detachment of the accessory to and from the image pickup apparatus. That is, in the camera mount, the contact pin (terminal) disposed farther than other contact pins does not slide against (contact) any contact surface other than the contact surface that contacts the contact pin while the accessory is attached to the image pickup apparatus. In the lens mount, a contact surface (terminal) located nearer than other contact surfaces does not slide (contact) with any contact pin other than the contact pin that contacts the contact surface while the accessory is attached to the image pickup apparatus.

However, for terminals other than these terminals, as the attachment/detachment number of the lens mount to/from the camera mount increases, these terminals are worn. In particular, the terminals (contact pins) of the camera mount are movable pins that can advance and retract (protrude and retract) in the direction parallel to the optical axis, and slide at a single point at a tip against terminals (contact surfaces) of the lens mount. Thus, the durability of the contact pins against sliding is to be improved.

The above problem becomes more significant as the number of terminals arranged in a line on the same surface orthogonal to the optical axis increases, and the number of sliding events between the contact pins and the contact surfaces increases. The wear of the contact pins and contact surfaces increases contact impedance of the terminals, thereby increasing a voltage drop, and when the voltage drops below a permissible operation voltage range of the electric circuit, malfunction of, for example, the interchangeable lens may occur.

Accordingly, in the present embodiment, in order to reduce the number of sliding events between terminals, positions at which terminals are held in the optical axis direction are made different between the upper step and the lower step on the camera-mount side. On the lens-mount side, positions are made different among the upper step, the middle step, and the lower step, and contact heights between camera-side contact pins and interchangeable-lens-side contact surfaces differ among the upper, middle, and lower steps. This configuration can suppress the wear between terminals for each step that holds terminals.

In the present embodiment, the number of terminals held differs among the upper, middle, and lower steps of the mount. Thus, for example, by arranging terminals of higher importance among the plurality of terminals on a side having fewer terminals, the wear of the important terminals can be suppressed. More specifically, the power supply terminals (VDD terminals, VBAT terminals, and PGND terminals), which are signal terminals for which it is desired to suppress an increase in contact impedance as much as possible, are arranged on the upper camera-mount step and the lower lens-mount step, which have fewer terminals. On the other hand, terminals mainly used for communication, which are less susceptible to an influence of impedance increase (as compared with the power supply terminals), are arranged on the lower camera-mount step and on the middle and upper lens-mount steps. This configuration can provide stable power supply to the accessory, which contributes to stabilizing operations of the accessory (e.g., focus control).

The DGND terminal 1012 in the camera mount A is located on the lower camera-mount step and is disposed at the frontmost side (starting end) in the lens attachment direction, and is therefore located at a position most disadvantageous in terms of the durability of the camera-side contact pin due to sliding. However, for the purpose of protecting electric circuits and elements provided in the accessory from static electricity and the like, the DGND terminal are physically ground-connected to a metal portion formed in the camera mount. In the present embodiment, the DGND terminal is disposed at the frontmost side in the lens attachment direction in order to facilitate processing for the above reason.

The present embodiment assumes a system in which a current level flowing through the DGND terminal is smaller than a current level flowing through the PGND terminal. Therefore, in the present embodiment, the PGND terminal through which a larger current level flows is disposed on the upper camera-mount step (lower lens-mount step) where fewer terminals are arranged and where it is advantageous for reducing an increase in contact impedance.

Next, in the camera mount A of the present embodiment, two power-supply contact pins (VDD terminal 1001 and VBAT terminal 1002) are arranged as the first and second pins when viewed from the rear side in the lens attachment direction on the upper camera-mount step. In the camera mount A of the present embodiment, the TYPE terminal 1003 is disposed adjacent to the power supply terminals. In the lens mount B of the present embodiment, two power-supply contact surfaces (VDD terminal 2001 and VBAT terminal 2002) are arranged as the first and second surfaces when viewed from the rear side in the lens attachment direction on the lower lens-mount step. In the lens mount B of the present embodiment, the TYPE terminal 2003 is disposed adjacent to the power supply terminals. Here, the state in which terminals are adjacent to each other indicates a state in which the terminals are next to each other in the mount.

Due to the above configuration, in the mount portion 1 of the present embodiment, the two power supply terminals (VDD terminal and VBAT terminal) and the PGND terminal are not adjacent to each other. Thus, short-circuiting between the two power supply terminals and the PGND terminal can be suppressed, and the malfunction or failure of a power supply circuit provided on the camera side due to the short-circuiting can be prevented.

The TYPE terminal 1003 disposed between the VBAT terminal 1002 and the PGND terminal 1004 can protect an electric circuit of the camera body 100 by providing a protective element on a signal line of the TYPE terminal 1003.

If a terminal other than the TYPE terminal is also provided with a protective element on its signal line as in the TYPE terminal 1003, similar countermeasures are possible. However, as described above, since the DCL terminal, the DLC terminal, the LCLK terminal, the DLC2 terminal, the DCA terminal, and the CS terminal are communication terminals, adding a protective element increases wiring capacitance. In this case, the increase in wiring capacitance may affect communication, for example, due to disturbing responsiveness of leading and trailing edges of the communication waveform. Thus, the protective elements may be provided as few as possible for communication terminals.

On the other hand, in the mount portion 1 of the present embodiment, the TYPE terminal 1003 has a constant signal voltage; for example, while the first interchangeable lens 200 is attached to the camera body 100, this signal value does not change. Thus, even if a protective element or the like is added to the TYPE terminal 1003 as in the mount portion 1 of the present embodiment, the influence on operations executed by the camera body 100 and the first interchangeable lens 200 is small.

The MIF terminal 1005 also has a constant signal voltage as in the TYPE terminal 1003, and may therefore be provided with a protective element as in the TYPE terminal 1003. However, in the mount portion 1 of the present embodiment, the MIF terminal 1005 is not disposed adjacent to the power supply terminals. The reason for this will be described later.

Next, as illustrated in FIG. 5C, in the camera mount A and the lens mount B, a pitch W2 (distance) between the VDD terminal and the VBAT terminal is configured to be larger than a basic pitch W1 (W2>W1). In the camera mount A and the lens mount B, the MIF terminal and the PGND terminal are held on different steps in the optical axis direction of each mount, and a pitch W3 between these terminals is configured to be larger than the basic pitch W1 and the pitch W2 (W3>W2>W1). In the present embodiment, the pitch between terminals is defined as a distance between centers (centerlines) of the terminals (contact pins and contact surfaces) in the attachment direction (rotation direction) of the lens mount B, but may be a distance between the conductive portions (metal regions) provided on the terminals. Alternatively, while the lens mount B is attached to the camera mount A, the pitch between terminals may be defined as a distance between contact locations (connection points) between corresponding contact pins and contact surfaces of adjacent terminals.

In the present embodiment, the widths of the contact surfaces of the VDD terminal 2001 and the VBAT terminal 2002 in the circumferential direction of the lens mount B are basic widths described later, but the present embodiment is not limited to this example. For example, the widths of the contact surfaces of the VDD terminal 2001 and the VBAT terminal 2002 may be larger than or smaller than the basic width. In this case, a pitch between the VDD terminal and the VBAT terminal is set in consideration of a difference between the widths of the VDD terminal 2001 and the VBAT terminal 2002 relative to the basic width. For example, in a case where the widths of the VDD terminal 2001 and the VBAT terminal 2002 are wider than the basic width toward a lens detachment direction, the pitch between the VDD terminal and the VBAT terminal is widened by an amount corresponding to the difference from the basic width.

The basic pitch described above is a distance between terminals set in consideration of play and tolerance involved in manufacturing and assembly of the camera body 100. As long as deformation such as bending of contact pins or conductive foreign matter is not present between terminals, contact pins on the camera mount A side for which the basic pitch is set are configured such that a single contact surface on the lens mount B side for which the basic width described later is set does not simultaneously contact a plurality of contact pins. Thus, adjacent terminals can be prevented from being short-circuited due to the contact of a contact pin on the camera mount A side with two or more contact surfaces of the lens mount B side. In the following description, unless otherwise specified, a pitch between adjacent terminals of a contact pin is assumed to be set to the basic pitch.

The basic width described above is a width of a contact surface on the lens mount B side set in consideration of play and tolerance involved in manufacturing and assembly of the accessory. The width of the contact surface is the width of each contact surface in the attachment direction (rotation direction) of the lens mount B. As described above, a plurality of contact pins on the camera mount A side for which the basic pitch is set do not simultaneously contact one contact surface for which the basic width is set. As long as the deformation of contact pins or conductive foreign matter is not present between contact pins, the contact surface on the lens mount B side for which the basic width is set is configured such that, in the attached state of the accessory, the contact pins on the image pickup apparatus side do not come off the contact surface on the accessory side. In the following description, unless otherwise specified, the width of the contact surface is assumed to be set to the basic width.

In the present embodiment, the pitch between the camera-side VDD terminal 1001 and the camera-side VBAT terminal 1002 is set to be wider by about 3° than the widths of the accessory-side VDD terminal 2001 and the accessory-side VBAT terminal 2002 for which the basic width is set, in consideration of the miniaturization of the unit and the safety of the power supply. Even if the deformation of the camera-side VDD terminal or VBAT terminal occurs or conductive foreign matter is present between these terminals, this configuration can reduce a likelihood that the accessory-side VDD terminal simultaneously comes into contact with the two terminals described above, thereby reducing the short-circuiting between adjacent terminals.

In the present embodiment, the pitch between the VDD terminal 1001 and the VBAT terminal 1002 in the circumferential direction of the camera mount A is widened by 3° relative to the basic pitch, but the present embodiment is not limited to this example. The present embodiment may have a configuration in which at least the pitch between terminals is widened in the relative rotation direction between the camera mount A and the lens mount B.

Next, in the mount portion 1 of the present embodiment, the PGND terminal 1004 is disposed on the frontmost side in the lens attachment direction on the upper camera-mount step, and the PGND terminal 2004 is disposed at the frontmost side in the lens attachment direction on the lower lens-mount step.

The PGND terminal 2004 in the lens mount B is a contact surface having a width larger than the basic width described above, and has the widest contact surface among the plurality of terminals provided in the lens mount B. In the present embodiment, the width of a contact surface is defined as a width of the contact surface toward a direction in which the attachment of the lens mount B to the camera mount A is released (detachment direction) on the basis of a location (connection point) at which corresponding terminals are electrically connected. This detachment direction is synonymous with the front side in the attachment direction of the lens mount B. Alternatively, the width of the contact surface may be defined simply as the width of the contact surface toward a direction in which the attachment of the lens mount B to the camera mount A is released (detachment direction) on the basis of the center of the contact surface in the circumferential direction of the mount.

Due to this configuration, the PGND terminal 2004 is a terminal that is electrically connected to a corresponding terminal first among all terminals when the first interchangeable lens 200 is attached to the camera body 100. The PGND terminal 2004 is a terminal whose electrical connection to a corresponding terminal is released last among all terminals when the attachment of the first interchangeable lens 200 to the camera body 100 is released (detached).

For example, assume a case where the PGND terminal is disposed farther than power supply terminals (VDD terminal and VBAT terminal) in the lens attachment direction. In this case, when the first interchangeable lens 200 is detached from the camera body 100, for example, the PGND terminal of the lens mount may slide against the power supply terminal of the camera mount. In this case, depending on the speed of rotating the first interchangeable lens 200 in the detachment direction, the PGND terminal of the lens mount may momentarily contact the power supply terminal of the camera mount. Thus, the above problem may cause short-circuiting in the output of the camera power supply unit 103 of the camera body 100, which is connected to the power supply terminal (described later), which may result in malfunctions related to the power supply or malfunctions in the power supply control.

For example, assume that the PGND terminal is disconnected from the contact surface on the lens-mount side earlier than other terminals. In this case, in particular, if the connection between the power supply terminals on the camera-mount A side and the lens-mount B side is not yet released and the power supply from the camera body 100 is maintained, the disconnection between the PGND terminals may cause malfunction or the like in both apparatuses.

To address the above problems, in the mount portion 1 of the present embodiment, when the first interchangeable lens 200 is attached to or detached from the camera body 100, the PGND terminal 2004 of the lens mount B does not slide against (contact) any terminal other than the PGND terminal 1004 of the camera mount A. With this configuration, since the power supply terminals (VDD terminal and VBAT terminal) of the camera mount A do not momentarily contact the PGND terminal 2004 of the lens mount B, this configuration can suppress the short-circuiting between these terminals.

In the mount portion 1 of the present embodiment, among all terminals described above, the PGND terminals of both mounts are connected first when the accessory is attached to the camera side, and their connection is released last when the accessory is detached. In other words, when the accessory is removed (detached) from the camera side, the PGND terminals maintain a connected state between the camera-side mount and the lens-side mount until connections between other corresponding terminals are released. This configuration can avoid so-called ground floating, in which connection between the PGND terminals is released while the power supply is maintained, thereby reducing malfunction or the like in both apparatuses.

As illustrated in FIG. 5C, in the camera mount A and the lens mount B, a pitch between the PGND terminal 1004 and the adjacent TYPE terminal 1003 is wider than the above-described basic pitch (W2>W1). More specifically, the pitch between the PGND terminal 1004 and the TYPE terminal 1003 is widened by approximately the same amount as the increased width of the contact surface of the PGND terminal 2004 toward the direction for detaching the lens mount B (detachment direction) relative to the basic pitch. This configuration can reduce a likelihood that the PGND terminal 2004 simultaneously contacts the PGND terminal 1004 and the TYPE terminal 1003 due to widening of the PGND terminal 2004 beyond the basic width, thereby reducing the short-circuiting between adjacent terminals.

Next, as illustrated in FIGS. 5A, 5B, and 5C, in the mount portion 1 of the present embodiment, the MIF terminal 1005 is disposed at the rearmost side in the lens attachment direction on the lower camera-mount step, and the MIF terminal 2005 is disposed on the middle lens-mount step. Then, among the eight terminals provided on the lower camera-mount step, a distance between the camera-side mount and the lens-side mount at a portion where the MIF terminals 1005 and 2005 are connected becomes wider than those at the other seven terminals.

The terminals on the camera-mount side have a structure in which they are pressed against the terminals on the lens-mount side by a spring structure. Thus, placing the MIF terminal 2005 on the middle lens-mount step so that a distance to the opposing terminal is wider than that of terminals on the upper lens-mount step can reduce contact pressure when the camera-mount-side contact pin is connected to the MIF terminal 2005. Some degree of contact pressure is provided between the camera-mount-side and lens-mount-side terminals to secure the electrical connection, but the higher the contact pressure is, the greater the wear of terminal surfaces is due to sliding during the attachment and detachment.

The surface of the MIF terminal 2005 on the lens-mount B side is worn due to contacting the eight terminals on the lower camera-mount step during the attachment and detachment. Reducing the contact pressure with terminals on the lower camera-mount step can reduce a force applied to the terminal surface of the MIF terminal 2005 in the optical axis direction during the attachment and detachment, thereby reducing wear of the terminal surface. This configuration can reduce the contact pressure of the MIF terminal, which is a terminal that detects an attached state of the lens mount B to the camera mount A while the mounts are attached and serves as a trigger terminal for starting and ending the communication between the camera and the accessory, compared with other terminals, thereby reducing the wear.

The above configuration secures the connections for the terminals on both the upper step and the middle step of the lens-mount side having different positions in the optical axis direction, to the terminals on the lower camera-mount step.

Thus, a positional difference in the optical axis direction between the upper step and the middle step provided on the lens-mount side may be smaller than a positional difference in the optical axis direction between a case where a spring-structure pin, which is a terminal of the camera mount A, is extended to the maximum and a case where the pin is pushed in to the maximum. Similarly, a positional difference in the optical axis direction between the upper lens-mount step and the lower lens-mount step may correspond to a difference in positions in the optical axis direction between the lower camera-mount step and the upper camera-mount step. Thus, a retraction amount in the optical axis direction of the middle lens-mount step relative to the upper lens-mount step may be defined relative to a positional difference in the optical axis direction between the upper lens-mount step and the lower lens-mount step.

The retraction amount of the middle lens-mount step relative to the upper lens-mount step in the optical axis direction may be 1.2 mm or less. In a case where the retraction amount is 1.2 mm or less, a maximum extension amount in a case where a spring-structure pin of the camera-mount terminal that contacts a lens-mount terminal is extended to the maximum can be maintained 1.2 mm or less. As a result, the accuracy of a position at which a tip of the camera-mount terminal pin contacts the lens-mount terminal can be satisfactorily maintained. On the other hand, in a case where the retraction amount is 1.2 mm or more, the maximum extension amount of the camera-mount terminal pin is larger than 1.2 mm, and the accuracy of the position at which the tip of the camera-mount terminal pin contacts the lens-mount terminal may be significantly reduced.

The MIF terminal 2005 of the lens mount B has the width of the contact surface narrower than that of the contact surface having the basic width in the relative rotation direction of the lens mount B. More specifically, in the lens mount B of the present embodiment, the width of the MIF terminal 2005 is made narrower (shorter) than the basic width by about 1° so that the above connection order of terminals is maintained even in consideration of play and tolerance in manufacturing and assembly. Due to this configuration, when the accessory is attached to the camera side, the MIF terminals are connected last among all terminals of the mount portion 1, and when the accessory is detached, the connection between the MIF terminals is released first.

Thus, in the mount portion 1 of the present embodiment, the erroneous detection of the attachment of the accessory on the camera side can be prevented, while the lens mount B is not completely attached to the camera mount A. For example, while the power supply terminals are not connected, this configuration can suppress erroneous detection of the attachment of an accessory, thereby reducing malfunction of the camera before the power supply from the camera side to the accessory side.

As illustrated in FIGS. 5A, 5B, and 5C, in the camera mount A of the present embodiment, the DGND terminal 1012 is disposed on the frontmost side in the lens attachment direction on the lower camera-mount step, and the CS terminal 1011 is disposed adjacent to the DGND terminal 1012. In the lens mount B of the present embodiment, the DGND terminal 2012 is disposed on the frontmost side in the lens attachment direction on the upper lens-mount step, and the CS terminal 2011 is disposed adjacent to the DGND terminal 2012. Details of arrangement of the CS terminal will be described later. As described above, the DGND terminal is disposed on the frontmost side in the lens attachment direction in consideration of ease of processing for physically connecting a metal portion of the mount to ground.

As illustrated in FIGS. 5A, 5B, and 5C, in the mount portion 1 of the present embodiment, the terminals of the first communication unit (LCLK terminal, DCL terminal, and DLC terminal) are arranged on the rear side in the lens attachment direction. In the mount portion 1 of the present embodiment, the terminals corresponding to the first communication unit are arranged farther than terminals corresponding to the second and third communication units in the lens attachment direction.

In the lower camera-mount step and the upper lens-mount step, this configuration can suppress the wear of terminals corresponding to the first communication unit. Thus, this configuration can suppress the wear of a terminal group corresponding to the first communication unit that performs first communication, which is particularly important among communications performed between the camera side and the lens side, more than other communication terminals.

As illustrated in FIGS. 5A, 5B, and 5C, in the mount portion 1 of the present embodiment, the DLC2 terminal 1009 is disposed adjacent to a terminal group corresponding to the first communication unit on the lower camera-mount step. In the mount portion 1 of the present embodiment, the DLC2 terminal 2009 is disposed adjacent to a terminal group corresponding to the first communication unit on the upper lens-mount step. Details will be described later.

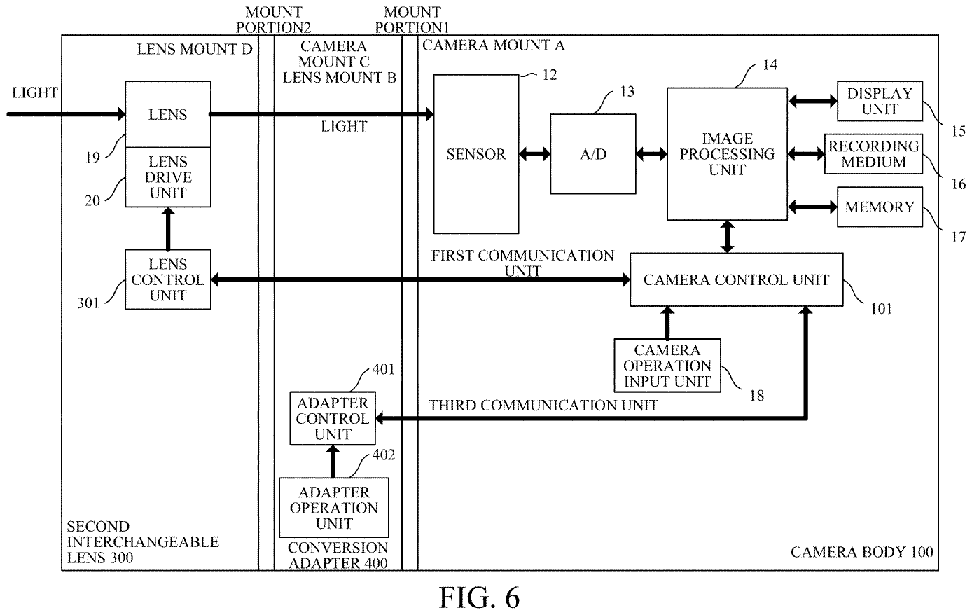

Next, with reference to FIG. 6, a case where the second interchangeable lens 300 is attached to the camera body 100 via the conversion adapter 400 will be described. FIG. 6 is a block diagram illustrating the second interchangeable lens 300 attached to the camera body 100 via the conversion adapter 400 according to the present embodiment. As illustrated in FIG. 6, mounts of the conversion adapter 400 and the second interchangeable lens 300 will be collectively referred to as a mount portion 2.

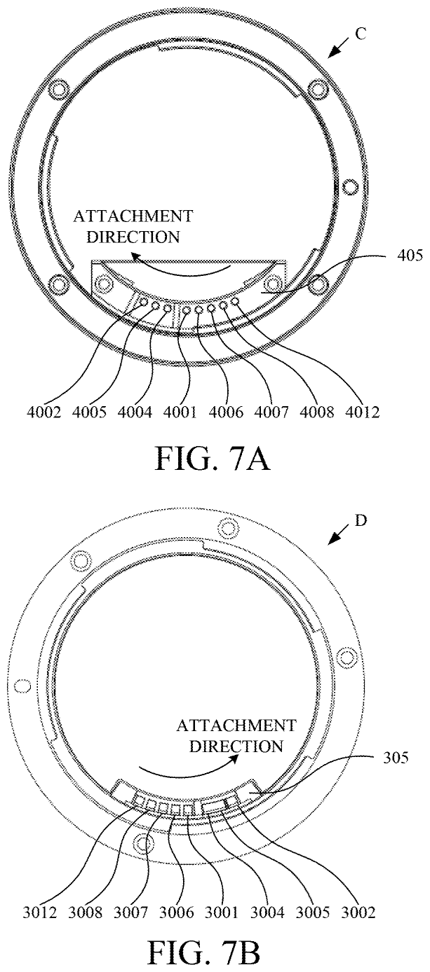

The conversion adapter 400 includes the same lens mount B as that of the first interchangeable lens 200 described above on a side to which the camera body 100 is coupled. The conversion adapter 400 further includes, on a side opposite to the lens mount B, a camera mount C corresponding to the lens mount D provided in the second interchangeable lens 300. FIGS. 7A and 7B are diagrams illustrating the camera mount C and the lens mount D according to the present embodiment. FIG. 7A is a front view of the camera mount C provided in the conversion adapter 400, and FIG. 7B is a front view of the lens mount D provided in the second interchangeable lens 300. Details of respective terminals provided in the camera mount C and the lens mount D will be described later.

The conversion adapter 400 is an accessory that includes an adapter operation input unit 402 that accepts an operation input by a user, an adapter power supply unit 403 for the conversion adapter 400, and an adapter control unit 401 including a CPU that comprehensively controls operations of the conversion adapter 400. The adapter control unit 401 controls, for example, communication between the adapter control unit 401 and the camera control unit 101 via the mount portion 1, or accepts an operation input to the adapter operation input unit 402. In the present embodiment, the conversion adapter 400 is used, for example, to indirectly attach the second interchangeable lens 300, which is an interchangeable lens having a flange-back length not supported by the camera body 100, to the camera body 100.

On the other hand, the second interchangeable lens 300 includes a lens 19 having optical members such as a focus lens, a zoom lens, an aperture stop, and an image stabilizing lens (not illustrated). The second interchangeable lens 300 further includes a lens drive unit 20 that drives actuators for moving or operating a structure (e.g., an optical member) provided inside the lens 19. The second interchangeable lens 300 further includes a lens control unit 301 including a CPU that controls communication between the lens control unit 301 and the camera control unit 101 via the mount portions 1 and 2, and/or performs control for driving the lens drive unit 20.

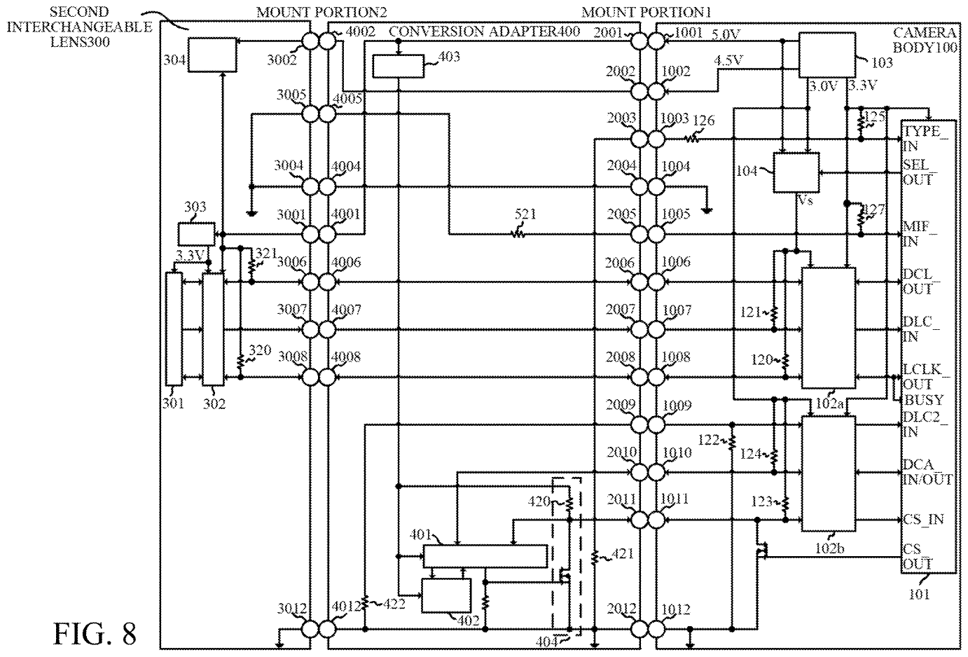

Next, with reference to FIG. 8, a connection configuration between the camera body 100 and the second interchangeable lens 300 via the conversion adapter 400 will be described. FIG. 8 is a diagram illustrating, by way of example, connection states between respective mounts in a case where the second interchangeable lens 300 is attached to the camera body 100 via the conversion adapter 400 according to the present embodiment. Since the configurations of the respective terminals in the mount portion 1 are as described above, a description thereof will be omitted. In the present embodiment, the DLC2 terminal on a second-interchangeable-lens-300 side (camera mount C side) of the conversion adapter 400 may be omitted.

As illustrated in FIG. 8, the mount portion 2 includes a plurality of terminals that enable electrical connection between the conversion adapter 400 and the second interchangeable lens 300. The plurality of terminals are exposed to the outside of the conversion adapter 400 as a plurality of electrical contact pins provided in a contact holding member 405 corresponding to a terminal holder in the camera mount C. The plurality of terminals are exposed to the outside of the second interchangeable lens 300 as a plurality of electrical contact surfaces provided in a contact surface holding member 305 corresponding to a terminal holder in the lens mount D. The above contact pins and contact surfaces are electrically connected to corresponding contacts while the second interchangeable lens 300 is attached to the conversion adapter 400 attached to the camera body 100.

Functions of respective terminals common to the camera mount C and the lens mount D will now be described. VDD terminals 3001 and 4001 are terminals for supplying, from the camera body 100 to the second interchangeable lens 300 and the conversion adapter 400, a communication control power supply (VDD) serving as communication power mainly used for communication control. The voltage supplied from the camera body 100 to each accessory is 5.0 V.

VBAT terminals 3002 and 4002 are terminals for supplying, from the camera body 100 to the second interchangeable lens 300, a driving power supply (VBAT) serving as driving power mainly used for operation of a mechanical drive unit including an actuator such as a motor. The voltage supplied from the camera body 100 to each accessory is 4.5 V. The VDD terminal and the VBAT terminal described above are power supply terminals for supplying power from the camera body 100 to the accessory.

DGND terminals 3012 and 4012 are ground terminals (GND terminals) corresponding to the communication control power supply VDD. The DGND terminals 3012 and 4012 connect to the ground even circuits provided inside the conversion adapter 400.

PGND terminals 3004 and 4004 are ground (GND) terminals for connecting to ground a mechanical drive system including a motor (actuator) provided in the camera body 100 and the second interchangeable lens 300. That is, the PGND terminals are ground terminals corresponding to the driving power supply VBAT.

MIF terminals 3005 and 4005 are terminals for detecting that the second interchangeable lens 300 is attached to the camera body 100. The camera control unit 101 detects that the accessory is attached to or detached from the camera body 100 by detecting a voltage level indicated by the MIF terminal. Based on this detection, the camera control unit 101 controls, for example, to start power supply to the power supply terminals after detecting the attachment of the accessory, and to start communication between the camera body 100 and the second interchangeable lens 300 via the conversion adapter 400.

Next, communication terminals between the conversion adapter 400 and the second interchangeable lens 300 will be described. Unlike the first interchangeable lens 200 described above, the second interchangeable lens 300 includes only terminals corresponding to the first communication unit as an independent communication system.

LCLK terminals 3008 and 4008 are terminals of the first communication unit, and serve as terminals for a communication clock signal output from the camera body 100 to the second interchangeable lens 300, and terminals for the camera body 100 to monitor a busy state of the second interchangeable lens 300.

DCL terminals 3006 and 4006 are terminals of the first communication unit, and serve as terminals for communication data for bidirectional communication between the camera body 100 and the second interchangeable lens 300, and are a so-called CMOS output type interface. In the present embodiment, the CMOS output type has switch outputs for both H (High) and L (Low) voltage levels. In contrast, an open type described later has a switch output only on the L side.

DLC terminals 3007 and 4007 are terminals of the first communication unit, and serve as terminals for communication data output from the second interchangeable lens 300 to the camera body 100, and are a CMOS-type interface.

The VDD terminal, VBAT terminal, DGND terminal, PGND terminal, MIF terminal, LCLK terminal, DCL terminal, and DLC terminal are electrically connected in the conversion adapter 400 from the mount portion 1 side to the mount portion 2 side.

The connection configuration in the conversion adapter 400 for terminals not provided in the mount portion 2 will now be described. The TYPE terminals 1003 and 2003 provided in the mount portion 1 are pull-down connected to the DGND terminal in the conversion adapter 400 with a predetermined resistance value described later.

The DLC2 terminal is a terminal corresponding to the second communication unit described above, but is not used as a communication terminal in a case where the second interchangeable lens 300 is attached to the camera body 100 via the conversion adapter 400. Thus, the DLC2 terminals 1009 and 2009 are pull-down connected, as termination processing, to the DGND terminal in the conversion adapter 400 with a predetermined resistance value described later. In the conversion adapter 400, a signal line corresponding to the DLC2 terminal is pull-down connected to the signal line of the DGND terminal via a resistor R_DLC2_A422 having a predetermined resistance value in the conversion adapter 400.

The DCA terminal is a terminal corresponding to the third communication unit described above. In the mount portion 1, the DCA terminal is a communication data terminal for bidirectional communication between the camera body 100 and the conversion adapter 400, and is a so-called CMOS-type interface. In the mount of the conversion adapter 400, the DCA terminal is not connected between the mount portion 1 side and the mount portion 2 side.

The CS terminal is a terminal corresponding to the third communication unit described above. The CS terminal is a signal terminal for requesting communication between the camera body 100 and the conversion adapter 400, and is an open-type interface. In the mount of the conversion adapter 400, the CS terminal is not connected between the mount portion 1 side and the mount portion 2 side.

Here, in a case where the second interchangeable lens 300 is attached to the camera body 100 via the conversion adapter 400, a communication voltage at terminals corresponding to the first communication unit is set to the same voltage as VDD. A communication voltage at terminals corresponding to the second and third communication units is set to about 3.0 V. That is, in a case where the second interchangeable lens 300 is attached to the camera body 100 via the conversion adapter 400, the communication voltage in the first communication unit differs from the communication voltage in the second and third communication units.

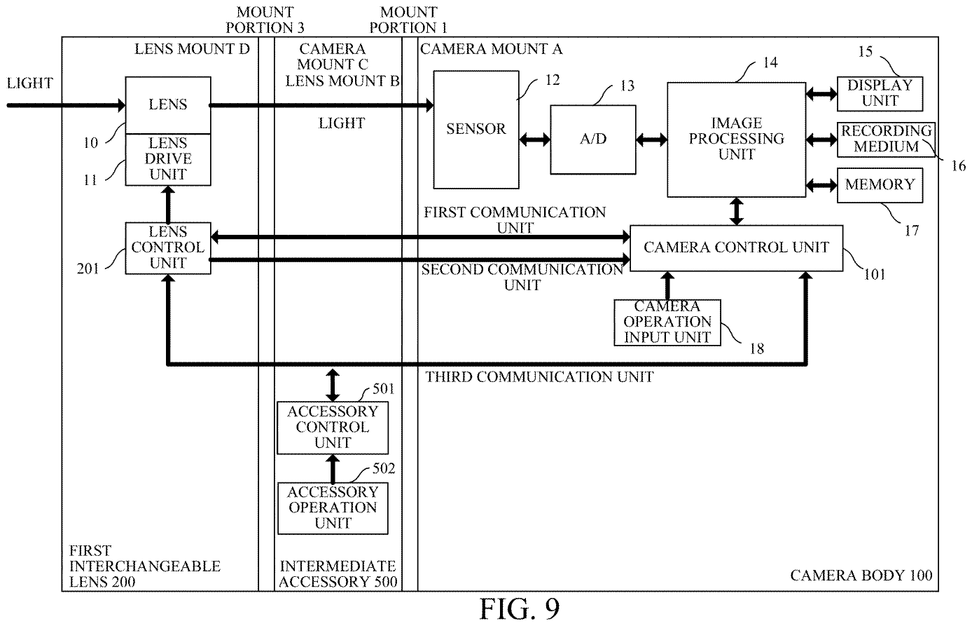

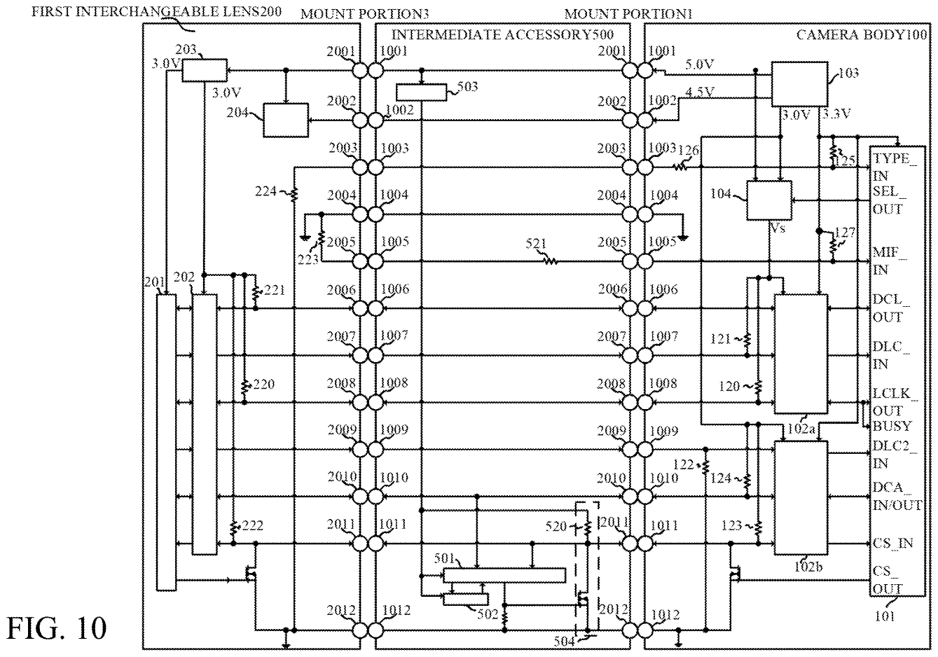

Next, with reference to FIGS. 9 and 10, a case where the first interchangeable lens 200 is attached to the camera body 100 via the intermediate accessory 500 will be described. FIG. 9 is a block diagram illustrating the first interchangeable lens 200 attached to the camera body 100 via the intermediate accessory 500 according to the present embodiment. As illustrated in FIG. 9, the mounts of the intermediate accessory 500 and the first interchangeable lens 200 will be collectively referred to as a mount portion 3.

The intermediate accessory 500 includes, on a side to which the camera body 100 is coupled, the same lens mount B as that of the first interchangeable lens 200 described above. The intermediate accessory 500 further includes, on a side opposite to the lens mount B, the same camera mount A as that of the camera body 100. Details of the mounts are the same as those of the camera body 100 and the first interchangeable lens 200 described above, and therefore a description thereof is omitted.

The intermediate accessory 500 is an accessory including an accessory operation input unit 502 that accepts an operation input by a user, an accessory power supply unit 503 for the intermediate accessory 500, and an accessory control unit 501 including a CPU that comprehensively controls operations of the intermediate accessory 500. The accessory control unit 501 controls, for example, communication between the accessory control unit 501 and the camera control unit 101 via the mount portion 1, and/or accepts an operation input to the accessory operation input unit 502. In the present embodiment, the intermediate accessory 500 is, for example, an extender including a lens unit (not illustrated) for magnification variation, or an accessory that can add some camera function as an operation of both the camera body 100 and the first interchangeable lens 200.

Next, with reference to FIG. 10, a connection configuration between the camera body 100 and the first interchangeable lens 200 via the intermediate accessory 500 will be described. FIG. 10 is a diagram illustrating, by way of example, connection states between respective mounts in a case where the first interchangeable lens 200 is attached to the camera body 100 via the intermediate accessory 500 according to the present embodiment. Since the configuration of the respective terminals in the mount portion 1 is as described above, a description thereof will be omitted.

As illustrated in FIG. 10, the mount portion 3 includes a plurality of terminals that enable electrical connection between the intermediate accessory 500 and the first interchangeable lens 200. Contact pins exposed to the outside of the intermediate accessory 500 as the respective terminals are the same as the contact pins of the camera body 100 described above.

The features of the intermediate accessory 500 for the camera body 100 and the first interchangeable lens 200 will now be described. As illustrated in FIG. 10, the intermediate accessory 500 can be connected via the terminals provided in each of the camera body 100 and the first interchangeable lens 200.

The VDD terminals 1001 and 2001 of the intermediate accessory 500 are through-wired between the mount portion 1 and the mount portion 3 and can also supply VDD (communication control power supply) to an electric circuit of the intermediate accessory 500.

The DGND terminals 1012 and 2012 of the intermediate accessory 500 are through-wired between the mount portion 1 and the mount portion 3 and can also ground an electric circuit of the intermediate accessory 500 to the DGND terminals.

The DCA terminals 1010 and 2010 of the intermediate accessory 500 are terminals corresponding to the third communication unit described above and are terminals for communication data for bidirectional communication among the camera body 100, the first interchangeable lens 200, and the intermediate accessory 500. The CS terminals 1011 and 2011 of the intermediate accessory 500 are terminals corresponding to the third communication unit described above and are signal terminals for requesting communication among the camera body 100, the first interchangeable lens 200, and the intermediate accessory 500.

Although not specifically described, the VBAT terminals, the PGND terminals, the MIF terminals, the TYPE terminals, the LCLK terminals, the DCL terminals, the DLC terminals, and the DLC2 terminals of the intermediate accessory 500 are through-wired between the mount portion 1 and the mount portion 3.

Here, in a case where the first interchangeable lens 200 is attached to the camera body 100 via the intermediate accessory 500, as in a case where the first interchangeable lens 200 is directly attached to the camera body 100, communication voltages at terminals corresponding to the first, second, and third communication units are set to about 3.0 V.

Next, with reference to FIGS. 3, 8, and 10, terminal processing of signal lines of the respective communication terminals will be described. In the camera mount A, a signal line corresponding to the LCLK terminal is pull-up connected to the same potential as a communication voltage of each terminal corresponding to the first communication unit via a resistor R_LCLK_C120 having a predetermined resistance value on the camera mount A side. In the lens mount B, a signal line corresponding to the LCLK terminal is pull-up connected to the same potential as a communication voltage of each terminal corresponding to the first communication unit via a resistor R_LCLK_L220 having a predetermined resistance value on the lens mount B side.

In the lens mount B, a signal line corresponding to the DCL terminal is pull-up connected to the same potential as a communication voltage of each terminal corresponding to the first communication unit via a resistor R_DCL_L221 having a predetermined resistance value on the lens mount B side.

In the camera mount A, a signal line corresponding to the DLC terminal is pull-up connected to the same potential as a communication voltage of each terminal corresponding to the first communication unit via a resistor R_DLC_C121 having a predetermined resistance value on the camera mount A side.

In the camera mount A, a signal line corresponding to the DLC2 terminal is pull-down connected to a signal line of the DGND terminal via a resistor R_DLC2_C122 having a predetermined resistance value on the camera mount A side. In the conversion adapter 400, a signal line corresponding to the DLC2 terminal is pull-down connected to the signal line of the DGND terminal via a resistor R_DLC2_A422 having a predetermined resistance value in the conversion adapter 400.

In the camera mount A, a signal line corresponding to the CS terminal is pull-up connected to the same potential as a communication voltage of each terminal corresponding to the third communication unit via a resistor R_CS_C123 having a predetermined resistance value on the camera mount A side. In the lens mount B, a signal line of the CS terminal is pull-up connected to the same potential as a communication voltage of each terminal corresponding to the third communication unit via a resistor R_CS_L222 having a predetermined resistance value on the lens mount B side. In the conversion adapter 400 and the intermediate accessory 500, signal lines of the CS terminal are pull-up connected to the same potential as a communication voltage of each terminal corresponding to the third communication unit via resistors R_CS_A420 and R_CS_A520 having predetermined resistance values in the respective apparatuses.

On the camera mount A side, a signal line of the DCA terminal is pull-up connected to the same potential as a communication voltage of a terminal corresponding to the third communication unit via a resistor R_DCA_C124 having a predetermined resistance value on the camera mount A side.

Next, with reference to FIGS. 3 and 8, the configurations of a first-communication I/F unit 102a and a second/third-communication I/F unit 102b that function as interface circuits between the respective communication terminals provided in the camera body 100 and the camera control unit 101 will be described.

As illustrated in FIGS. 3 and 8, the first-communication I/F unit 102a is provided inside the camera body 100. The first-communication I/F unit 102a is connected to the DCL terminal, the DLC terminal, and the LCLK terminal, and functions as an interface circuit for first communication performed between the camera body 100 and each interchangeable lens.

The second/third-communication I/F unit 102b is provided inside the camera body 100. The second/third-communication I/F unit 102b is connected to the DLC2 terminal, the DCA terminal, and the CS terminal, and functions as an interface circuit for the second communication and the third communication performed between the camera body 100 and each interchangeable lens. Hereinafter, the first-communication I/F unit 102a and the second/third-communication I/F unit 102b will be collectively referred to as an I/F unit 102. In the present embodiment, as illustrated in FIGS. 3 and 8, a case where the camera control unit 101 is driven at a voltage level of 3.3 V and the voltage level of the camera control unit 101 is 3.3 V will be described by way of example; however, other voltage levels may be employed.

The I/F unit 102 includes, as one of its main roles, a level shifter function for converting between a voltage indicated by terminals provided in the camera mount A and a voltage of the camera control unit 101. As the level shifter function, for example, in a case where the first interchangeable lens 200 is attached to the camera body 100, as described above, an interface voltage at each terminal corresponding to the first, second, and third communication units is 3.0 V. In contrast, the voltage of the camera control unit 101 is 3.3 V, and therefore a voltage difference arises between them. The I/F unit 102 performs voltage conversion of voltages indicated by the respective terminals to adjust this difference.

For example, in a case where the second interchangeable lens 300 is attached to the camera body 100 via the conversion adapter 400, as described above, an interface voltage at terminals corresponding to the first communication unit is the same voltage as VDD (5.0 V). An interface voltage at the terminals corresponding to the second and third communication units is 3.0 V. In this case, the I/F unit 102 performs voltage conversion of voltages indicated by the respective terminals to adjust a difference between these voltages. That is, voltage conversion of signals of the respective terminals is performed by supplying a power supply voltage (3.3 V) having the same voltage level as the voltage of the camera control unit 101 and a power supply voltage (5.0 V or 3.0 V) having the same voltage level as voltages indicated by the respective terminals.

For the second/third-communication I/F unit 102b, since a voltage level indicated by each terminal provided in the mount is always a fixed value, the level shifter function described above is not essential if the fixed value has the same voltage level as the voltage of the camera control unit 101.

The I/F unit 102 has, as one of its main roles, a function of switching the LCLK terminal 1008 and the DCL terminal 1006 on the camera mount A side between the open-drain type output and the CMOS output type output. Details will be described below.

For example, in the initial state just after the first interchangeable lens 200 is attached to the camera body 100, the LCLK terminal 1008 and the DCL terminal 1006 of the camera body 100 perform the open-drain type output. The camera control unit 101 monitors a voltage level of the LCLK terminal 1008 using, for example, a BUSY input terminal of the camera control unit 101 as illustrated in FIG. 3. For example, in a case where communication with the first interchangeable lens 200 is not possible or fails, a low level voltage is output to the LCLK terminal 2008 on the lens mount B side, and in a case where communication is possible, the LCLK terminal 2008 is switched to an input side. At this time, in an LCLK terminal line of each mount, a high level voltage is output by pull-up resistors R_LCLK_C120 and R_LCLK_L220.

On the other hand, upon detecting switching of a voltage level of the LCLK terminal 1008 to the high level, the camera control unit 101 recognizes that the first interchangeable lens 200 has become communicable. Thereafter, the camera control unit 101 selects whether to use the open-drain type output or the CMOS output type output for the LCLK terminal 1008 and the DCL terminal 1006, and changes to the selected output type using the I/F unit 102. Here, communication when the I/F unit 102 is used in the open-drain type will be referred to as open-drain communication, and communication when the I/F unit 102 is used in the CMOS output type will be referred to as CMOS communication.

When a high level voltage is detected from the LCLK terminal 1008 at the attachment of the first interchangeable lens 200, the camera control unit 101 switches the LCLK terminal 1008 and the DCL terminal 1006 to the CMOS output type and performs the CMOS communication with the first interchangeable lens 200. At the attachment of the second interchangeable lens 300, the camera control unit 101 performs the open-drain communication with the second interchangeable lens 300 while maintaining the LCLK terminal 1008 and the DCL terminal 1006 in the open-drain type. Thereafter, when determining that the second interchangeable lens 300 supports the CMOS communication, the camera control unit 101 switches the LCLK terminal 1008 and the DCL terminal 1006 to the CMOS output type using the I/F unit 102 and performs the CMOS communication with the lens side.

The above open type output method may be an open-collector output in addition to the open-drain output, and a high level voltage output may be achieved by providing a pull-up resistor as described above. A method of switching output methods is not limited to the above as long as at least, in a case where any interchangeable lens is attached to the camera body 100, the LCLK terminal 1008 and the DCL terminal 1006 perform the open-type communication.

The I/F unit 102 has, as one of its main roles, an input/output direction switching function for switching the input and output directions of the DCL terminal 1006 and the DCA terminal 1010 on the camera mount A side. As described above, since bidirectional communication data is exchanged via the DCL terminal and the DCA terminal, the input/output direction of signals is switched by the I/F unit 102.

In the present embodiment, a voltage indicated by communication terminals corresponding to the first communication unit is switched to either the same voltage as VDD or 3.0 V in accordance with a type of accessory attached to the camera body 100. On the other hand, a voltage indicated by communication terminals corresponding to the second and third communication units does not vary according to the type of accessory attached to the camera body 100, and is always a constant value (3.0 V).

The first-communication I/F unit 102a is supplied, from a camera power supply unit 103 described later, with one of a power supply voltage Vs that is either the same voltage as VDD or 3.0 V, and a power supply voltage (3.3 V) at the same potential as the voltage indicated by the camera control unit 101. The second/third-communication I/F unit 102b is supplied, from the camera power supply unit 103 described later, with the power supply voltage of 3.0 V and the power supply voltage (3.3 V) at the same potential as the voltage indicated by the camera control unit 101.

Next, with reference to FIGS. 3 and 8, the configuration of the camera power supply unit 103 that generates respective power supplies in the camera body 100 will be described. The camera power supply unit 103 generates a communication control power supply (VDD) as a power supply for supplying power to the attached accessory via the VDD terminal, or as a power supply for supplying power to the first-communication I/F unit 102a via a power supply switching unit 104 described later. The camera power supply unit 103 generates a driving power supply (VBAT) as a power supply for supplying power to the attached accessory via the VBAT terminal. As described above, in the present embodiment, the power supply voltage of VDD is 5.0 V and the power supply voltage of VBAT is 4.5 V.

The camera power supply unit 103 also generates a 3.3 V power supply as a power supply for supplying power to the camera control unit 101 and the I/F unit 102. The camera power supply unit 103 generates a 3.0 V power supply as a power supply for supplying power to the I/F unit 102 via the power supply switching unit 104 described later.

Next, details of the power supply switching unit 104 for switching a power supply (voltage) supplied to the first-communication I/F unit 102a will be described. The power supply switching unit 104 is connected to the camera power supply unit 103. The power supply switching unit 104 supplies, as a power supply Vs for a communication interface, only one of the VDD power supply and the 3.0 V power supply generated by the camera power supply unit 103 to the first-communication I/F unit 102a. Switching of the power supply voltage is performed in accordance with an instruction from the camera control unit 101.

Here, in a case where the camera control unit 101 determines, using the TYPE terminal 1003, that the type of accessory attached to the camera body 100 is the first interchangeable lens 200, the camera control unit 101 controls the power supply switching unit 104 such that the power supply Vs becomes the 3.0 V power supply. On the other hand, in a case where the camera control unit 101 determines that the second interchangeable lens 300 is attached to the camera body 100 via the conversion adapter 400, the camera control unit 101 controls the power supply switching unit 104 such that the power supply Vs for the communication interface has the same voltage as VDD. During a period in which the attachment of the accessory is not detected in the camera body 100 and during a period until the type of the attached is determined, the camera control unit 101 controls the power supply switching unit 104 such that the power supply Vs becomes the 3.0 V power supply. For example, in a case where the first interchangeable lens 200 is directly attached to the camera body 100, this configuration can prevent a voltage of 3.0 V or higher from being applied to an electric circuit of the first interchangeable lens 200 whose rated voltage is 3.0 V.

In the camera body 100, while the attachment of the accessory is not detected and during a period until the type of the attached accessory is determined, a configuration may be employed in which the power supply Vs for the communication interface is not supplied. Similarly, for the power supply (3.0 V) supplied to the second/third-communication I/F unit 102b, a configuration may be employed in which the power supply Vs is not supplied. Since a predetermined voltage is prevented from being applied to the respective terminals while power is not supplied from the camera side to the accessory side, this configuration can reduce unintended inflow of voltage/current between non-corresponding terminals when an accessory is not attached.

As described above, in the camera body 100, the camera control unit 101 controls the I/F unit 102 and the power supply switching unit 104, thereby making it possible to perform each communication at a proper voltage according to the type of accessory attached to the camera body 100.

Next, with reference to FIG. 3, a configuration of a lens-side I/F unit 202, which functions as an interface circuit between communication terminals provided in the first interchangeable lens 200 and the lens control unit 201, will be described.

As illustrated in FIG. 3, the first interchangeable lens 200 includes the lens-side I/F unit 202 as a communication interface unit in the first interchangeable lens 200. The lens-side I/F unit 202 functions as an interface circuit for enabling the camera body 100 and the first interchangeable lens 200 to communicate via terminals corresponding to each of the first, second, and third communication units.

The lens-side I/F unit 202 has, as one of its main roles, a level shifter function for converting between a voltage indicated by terminals provided in the lens mount B and a voltage indicated by the lens control unit 201. For example, in a case where a voltage level indicated by the lens control unit 201 differs from a voltage level indicated by each terminal, the lens-side I/F unit 202 performs voltage conversion of the voltage indicated by each terminal in accordance with the difference so as to adjust the difference. As illustrated in FIG. 3, in a case where the voltage level indicated by the lens control unit 201 is the same as the voltage level indicated by each terminal (3.0 V), the above level shifter function is not essential.

As one of its main roles, the lens-side I/F unit 202 has a function of switching, on the lens mount B side, the LCLK terminal 2008 to an input or an open-drain type output. As one of its main roles, the lens-side I/F unit 202 has a function of switching, on the lens mount B side, the DLC terminal 2007 to an open-drain type output or a CMOS output type output.

The control of the LCLK terminal 2008 and the DLC terminal 2007 in a case where the first interchangeable lens 200 is attached to the camera body 100 is as described above in the description of the communication interface on the camera body 100 side. That is, the lens control unit 201 controls the lens-side I/F unit 202 to switch output types of the LCLK terminal 2008 and the DLC terminal 2007 in accordance with a voltage level output from the LCLK terminal 2008.

As one of its main roles, the lens-side I/F unit 202 has an input/output direction switching function for switching input/output directions of the DCL terminal 2006 and the DCA terminal 2010 on the lens mount B side. As described above, since bidirectional communication data is performed via the DCL terminal and the DCA terminal, input/output directions of signals are switched by the lens-side I/F unit 202.

Next, with reference to FIG. 3, the configuration of a lens power supply unit 203 that generates respective power supplies in the first interchangeable lens 200 will be described. While the first interchangeable lens 200 is attached to the camera body 100, a communication control power supply (VDD) is supplied from the camera power supply unit 103 described above to the lens power supply unit 203 of the first interchangeable lens 200 via the VDD terminal. In this state, the lens power supply unit 203 generates, based on the VDD supplied from the camera body 100 side, a 3.0 V power supply as a power supply voltage to be supplied to the lens control unit 201 and the lens-side I/F unit 202.

While the first interchangeable lens 200 is attached to the camera body 100, a driving power supply (VBAT) is supplied from the camera power supply unit 103 described above to a driving circuit unit 204 on the first interchangeable lens 200 side via the VBAT terminal.

In the present embodiment, a power supply voltage level of the lens control unit 201 and a power supply voltage level of the lens-side I/F unit 202 are the same (3.0 V). However, a configuration may be adopted in which the voltage level indicated by the lens control unit 201 is set to 3.3 V. In that case, since the lens-side I/F unit 202 is supplied with power supplies of 3.0 V and 3.3 V voltage levels, the lens power supply unit 203 generates 3.0 V and 3.3 V power supplies.

Next, with reference to FIG. 8, a configuration of a lens-side I/F unit 302, which functions as an interface circuit between communication terminals provided in the second interchangeable lens 300 and the lens control unit 301, will be described.

As illustrated in FIG. 8, the second interchangeable lens 300 includes the lens-side I/F unit 302. The lens-side I/F unit 302 is connected to the DCL terminal 3006, the DLC terminal 3007, and the LCLK terminal 3008, and functions as an interface circuit for the first communication performed between the camera body 100 and the second interchangeable lens 300.

The lens-side I/F unit 302 includes, as one of its main roles, a level shifter function for converting between a voltage indicated by terminals provided in the lens mount D and a voltage indicated by the lens control unit 301. For example, assume a case where a voltage level indicated by each terminal is the same voltage as VDD and a voltage indicated by the lens control unit 301 is 3.3 V. Then, in order to adjust the difference between them, the lens-side I/F unit 302 performs voltage conversion of the voltage indicated by each terminal. In a case where the voltage level indicated by the lens control unit 301 is the same as the voltage level indicated by each terminal, this level shifter function is not essential.

As one of its main roles, the lens-side I/F unit 302 has a function of switching, on the lens mount D side, the LCLK terminal 3008 to an input or an open-drain type output. As one of its main roles, the lens-side I/F unit 302 has a function of switching, on the lens mount D side, the DLC terminal 3007 to an open-drain type output or a CMOS output type output.

The control of the LCLK terminal 3008 and the DLC terminal 3007 in a case where the second interchangeable lens 300 is attached to the camera body 100 via the conversion adapter 400 is as described above in the description of the communication interface relating to the first interchangeable lens 200. That is, the lens control unit 301 controls the lens-side I/F unit 302 to switch output types of the LCLK terminal 3008 and the DLC terminal 3007 in accordance with a voltage level output from the LCLK terminal 3008.

Next, with reference to FIG. 8, a configuration of a lens power supply unit 303 that generates respective power supplies in the second interchangeable lens 300 will be described. In a state where the second interchangeable lens 300 is attached to the camera body 100 via the conversion adapter 400, a communication control power supply (VDD) is supplied from the camera power supply unit 103 described above to the lens power supply unit 303 of the second interchangeable lens 300 via the VDD terminal. In this state, the lens power supply unit 303 generates, based on the VDD supplied from the camera body 100 side, a 3.3 V power supply as a power supply voltage to be supplied to the lens control unit 301 and the lens-side I/F unit 302.

While the second interchangeable lens 300 is attached to the camera body 100 via the conversion adapter 400, a driving power supply (VBAT) is supplied from the camera power supply unit 103 described above to a driving circuit unit 304 on the second interchangeable lens 300 side via the VBAT terminal.

Next, with reference to FIG. 8, the internal circuit configuration and operation of the conversion adapter 400 will be described. While the conversion adapter 400 is attached to the camera body 100, a communication control power supply (VDD) is supplied from the camera power supply unit 103 described above to an adapter power supply unit 403 of the conversion adapter 400 via the VDD terminal. In this state, the adapter power supply unit 403 generates, based on the VDD supplied from the camera body 100 side, a power supply to be supplied to an adapter control unit 401 including an adapter CPU and to an adapter operation input unit 402.

The adapter operation input unit 402 allows settings relating to manual focus and settings relating to an aperture diameter, etc., based on a user operation input, and includes, as a manually operable operation member, for example, a ring member rotatable in a circumferential direction of the conversion adapter 400.

The adapter control unit 401 asserts/negates a communication request of the CS terminal 2011 provided in the lens mount B of the conversion adapter 400 by controlling an open interface unit 404 formed of an N-channel transistor. The adapter control unit 401 receives a voltage level of the CS terminal 2011 and monitors the voltage level of the CS terminal 2011.

Operation information input by the adapter operation input unit 402 is reflected to various settings of the camera body 100 through the third communication via terminals corresponding to the third communication unit, between the adapter control unit 401 and the camera control unit 101. More specifically, in a case where the adapter control unit 401 detects operation information input to the adapter operation input unit 402, the adapter control unit 401 controls the open interface unit 404 to transmit a communication request to the camera control unit 101 using the CS terminal 2011 corresponding to the third communication unit. In this case, the adapter control unit 401 transmits the detected operation information to the camera control unit 101 using the DCA terminal 2010 corresponding to the third communication unit.

Next, with reference to FIG. 10, the internal circuit configuration and operation of the intermediate accessory 500 will be described. While the intermediate accessory 500 is attached to the camera body 100, a communication control power supply (VDD) is supplied from the camera power supply unit 103 described above to an accessory power supply unit 503 of the intermediate accessory 500 via the VDD terminal. In this state, the accessory power supply unit 503 generates, based on the VDD supplied from the camera body 100 side, a power supply to be supplied to an accessory control unit 501 including an accessory CPU and to an accessory operation input unit 502.

The accessory operation input unit 502 allows settings relating to manual focus and settings relating to an aperture diameter, etc., based on a user operation input, and includes, as a manually operable operation member, for example, a ring member rotatable in a circumferential direction of the intermediate accessory 500.

The intermediate accessory 500 includes an open interface unit 504 formed of an N-channel transistor, similarly to the conversion adapter 400 described above. Although a control target differs, the open interface unit 504 operates approximately the same as the open interface unit 404 described above, and thus a description thereof will be omitted.

Operation information input by the accessory operation input unit 502 is reflected in various settings of the camera body 100 through the third communication, via terminals corresponding to the third communication unit, between the accessory control unit 501 and the camera control unit 101 or the lens control unit 201. More specifically, in a case where the accessory control unit 501 detects operation information input to the accessory operation input unit 502, the accessory control unit 501 controls the open interface unit 504 to transmit a communication request to the camera control unit 101 using the CS terminal 2011 corresponding to the third communication unit. In this case, the accessory control unit 501 transmits the detected operation information to the camera control unit 101 using the DCA terminal 2010 serving as the third communication unit.

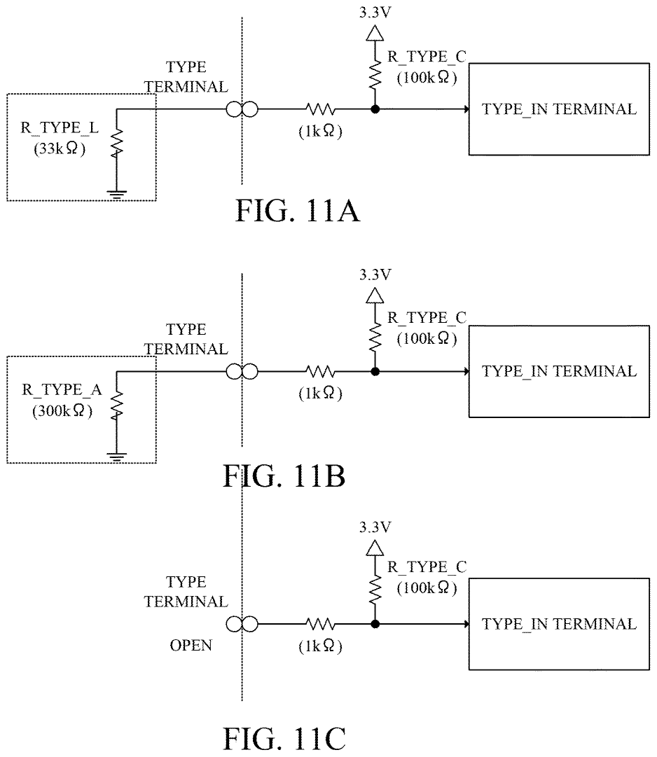

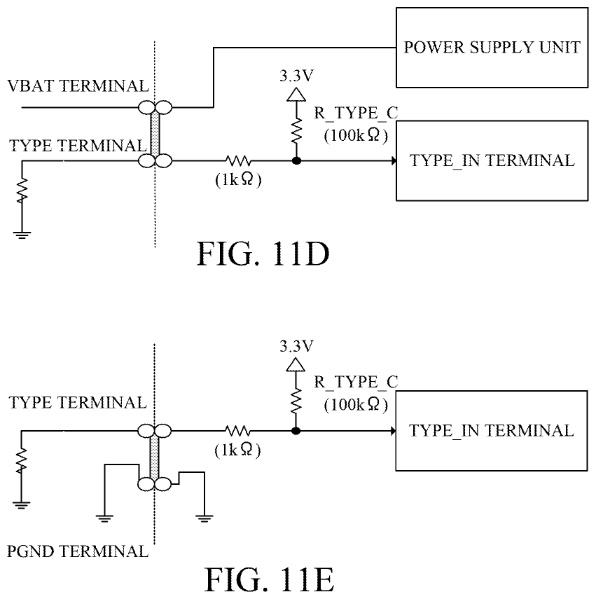

Next, with reference to FIGS. 11A to 11E and Table 1 below, a method of determining, on the camera body 100 side, a type of an accessory attached to the camera body 100 will be described. More specifically, a method will be described in which, in the camera body 100, the camera control unit 101 determines a type of an accessory attached to the camera body 100 based on a voltage level indicated by the TYPE terminal 1003.

TABLE 1

| | | FIRST | | SECOND | |
|---|---|---|---|---|---|
| | | INTERCHANGEABLE | | INTERCHANGEABLE | |
| ATTACHED LENS | ERROR | LENZ | RESERVED | LENS | ERROR |
| TYPE_IN | 0x0000~0x007F | 0x0080~0x017F | 0x0180~0x027F | 0x0280~0x037F | 0x0380~0x03FF |
| TERMINAL | | | | | |
| COMMUNICATION | NO | 3.0 V | NO | VDD (5.0 V) | NO |
| VOLTAGE | COMMUNICATION | | COMMUNICATION | | COMMUNICATION |

Table 1 is a table indicating a relationship between an input signal of the TYPE terminal and a communication voltage in a case where each accessory is attached to the camera body 100 (including errors, etc.). In the present embodiment, as illustrated in Table 1, information (table data) indicating a relationship between a voltage level indicated by a TYPE_IN terminal and the attached accessory is stored in a memory (not illustrated) provided in the camera control unit 101. The table data may be stored in any memory region of a storage provided inside the camera body 100.

In a case where the first interchangeable lens 200 is attached to the camera body 100, the TYPE terminal 1003 is pull-up connected, via a resistor R_TYPE_C126, to a power supply indicating a voltage level of 3.3 V. In this case, the TYPE terminal 1003 is pull-down connected, via a resistor R_TYPE_L224, to the DGND terminal side. In this case, a voltage obtained by dividing the 3.3 V power supply by resistance values of the resistor R_TYPE_C126 and the resistor R_TYPE_L224 is input to the camera control unit 101. In the present embodiment, resistance values indicated by the respective resistors described above are set, in view of a case where short-circuiting occurs between terminals, in accordance with a ratio to resistance values indicated by other resistors connected to terminals that may be short-circuited.

In a case where the conversion adapter 400 is attached to the camera body 100, the TYPE terminal is pull-up connected, via the resistor R_TYPE_C126, to the power supply indicating the voltage level of 3.3 V, and is pull-down connected, via a resistor R_TYPE_A421, to the DGND terminal side. In this case, a voltage obtained by dividing the 3.3 V power supply by resistance values of the resistor R_TYPE_C126 and the resistor R_TYPE_A421 is input to the camera control unit 101.

Here, the camera control unit 101 includes an A/D converter that converts an analog data signal into a digital data signal and includes the TYPE_IN terminal as an input port of the A/D converter. The TYPE terminal 1003 is connected to the TYPE_IN terminal. For description purposes, assume that a resolution of the A/D converter is 10 bits (1024 divisions: 0x0000 to 0x03FF). Between the TYPE terminal 1003 and the TYPE_IN terminal, a resistor having a predetermined resistance value (in the present embodiment, 1 kΩ) is connected to protect the TYPE_IN terminal.

For description purposes, predetermined resistance values indicated by the respective resistors are as follows as an example. A resistance value of the resistor R_TYPE_C126 indicating a pull-up resistance value in the camera body 100 is 100 kΩ. A resistance value of the resistor R_TYPE_L224 indicating a pull-down resistance value in the first interchangeable lens 200 is 33 kΩ. A resistance value of the resistor R_TYPE_A421 indicating a pull-down resistance value in the conversion adapter 400 is 300 kΩ.

The camera control unit 101 determines a type of an accessory attached to the camera body 100 in accordance with a voltage level input to the TYPE_IN terminal. More specifically, the camera control unit 101 A/D-converts the voltage level input to the TYPE_IN terminal, and determines the accessory type by comparing the A/D-converted voltage value with a threshold (reference value) corresponding to a lens type that is stored in advance in a memory (not illustrated) of the camera control unit 101.

Specific determination methods for respective accessories will now be described. FIGS. 11A to 11E are diagrams illustrating, by way of example, connection states between the TYPE_IN terminal of the camera body 100 and respective accessories in the present embodiment. FIG. 11A illustrates a case where the first interchangeable lens 200 is attached to the camera body 100. FIG. 11B illustrates a case where the conversion adapter 400 is attached to the camera body 100. FIG. 11C illustrates a case where TYPE terminals provided in the camera body 100 and an accessory are not in proper contact due to poor contact or the like. FIG. 11D illustrates a case where the TYPE terminal is short-circuited to an adjacent VBAT terminal due to adhesion of a conductive foreign substance between terminals or the like. FIG. 11E illustrates a case where the TYPE terminal is short-circuited to an adjacent PGND terminal due to adhesion of a conductive foreign substance between terminals or the like.

As illustrated in FIG. 11A, in a case where the first interchangeable lens 200 is attached to the camera body 100, a voltage level input to the TYPE_IN terminal of the camera control unit 101 (after A/D conversion) is approximately “0x0103”. In the state illustrated in FIG. 11A, the voltage level input to the TYPE_IN terminal is determined based on a ratio (division ratio) between the pull-up resistor (100 kΩ) and the protection resistor (1 kΩ) in the camera body 100 and the pull-down resistor (33 kΩ) in the first interchangeable lens 200.

The camera control unit 101 compares the table data stored in the memory (see Table 1) with the voltage level input to the TYPE_IN terminal. For example, in a case where the voltage level input to the TYPE_IN terminal (after A/D conversion) is “0x0103”, the voltage level falls within a range “0x0080 to 0x017F” indicating that the first interchangeable lens 200 is attached, as illustrated in Table 1. In this case, the camera control unit 101 determines that the first interchangeable lens 200 is attached to the camera body 100.

As illustrated in FIG. 11B, in a case where the conversion adapter 400 is attached to the camera body 100, a voltage level input to the TYPE_IN terminal of the camera control unit 101 (after the A/D conversion) is approximately “0x0300”. In the state illustrated in FIG. 11B, the voltage level input to the TYPE_IN terminal is determined based on a ratio (division ratio) between the pull-up resistor (100 kΩ) and the protection resistor (1 kΩ) in the camera body 100 and the pull-down resistor (300 kΩ) in the conversion adapter 400.

In this case, the voltage level input to the TYPE_IN terminal (after A/D conversion) is “0x0300”. Therefore, the voltage level falls within a range “0x0280 to 0x037F” indicating that the conversion adapter 400 is attached, as illustrated in Table 1. Thus, the camera control unit 101 determines that the conversion adapter 400 is attached to the camera body 100.

Next, as illustrated in FIG. 11C, in a case where the TYPE terminals of the camera body 100 and the accessory have poor contact, a voltage level input to the TYPE_IN terminal of the camera control unit 101 is approximately “0x03FF”. In this case, the voltage level input to the TYPE_IN terminal is determined only by the pull-up resistor (100 kΩ) in the camera body 100.

In the above case, the voltage level input to the TYPE_IN terminal is a voltage that does not correspond to either the first interchangeable lens 200 or the conversion adapter 400. In this case, as illustrated in Table 1, the voltage level input to the TYPE_IN terminal corresponds to error 1, and therefore the camera control unit 101 cannot determine the accessory attached to the camera body 100. The state illustrated in FIG. 11C corresponds to, for example, a case where the MIF terminals of the camera body 100 and the accessory are properly connected but the TYPE terminals are not in contact.

Next, as illustrated in FIG. 11D, in a case where the TYPE terminal is short-circuited to an adjacent terminal due to the adhesion of a conductive foreign substance between the TYPE terminal and the adjacent VBAT terminal, or the like, a signal line on the VBAT terminal side is connected to the TYPE terminal. Here, in a case where the type of the accessory attached to the camera body 100 is determined before power supply to the VBAT terminal, a determination result may differ according to a state of the VBAT power supply.

For example, in a case where the VBAT power supply is turned off and a signal line of the VBAT power supply becomes at the same potential as a signal line of the PGND terminal, the signal line of the TYPE terminal becomes at the same potential as the signal line of the PGND terminal. In this case, the voltage level input to the TYPE_IN terminal is determined based on a ratio (division ratio) between the pull-up resistor (100 kΩ) and the protection resistor (1 kΩ) in the camera body 100, and becomes approximately “0x000A”. In this case, since the voltage level input to the TYPE_IN terminal corresponds to error 1 illustrated in Table 1, the camera control unit 101 cannot determine the accessory attached to the camera body 100.

For example, in a case where the VBAT power supply is turned off and a signal line of the VBAT power supply is floating, there is no influence of the short-circuiting between the TYPE terminal and the VBAT terminal, and the accessory type can be determined as described above. Thereafter, when VBAT power is supplied to the VBAT terminal while the VBAT terminals are connected, a voltage corresponding to the VBAT power supply voltage is applied to the TYPE terminal. In this case, since the VBAT terminal indicates a voltage level higher than a power supply voltage of the TYPE_IN terminal, a current of an unintended voltage level may flow into the TYPE_IN terminal via a diode (not illustrated) present in the TYPE_IN terminal.

Accordingly, in the camera body 100 of the present embodiment, a protection resistor (1 kΩ) is provided in series in the signal line of the TYPE terminal. This configuration can reduce inflow of a current of an unintended voltage level into the TYPE_IN terminal (power supply), and suppress occurrence of malfunction or the like in each unit connected to the TYPE_IN terminal. A configuration may be adopted in which a protection diode is connected to the signal line between the protection resistor (1 kΩ) and the TYPE_IN terminal.

The camera control unit 101 may be configured to detect again a voltage level input to the TYPE_IN terminal and re-determine the accessory type when VBAT power is supplied to the VBAT terminal. In this case, in the state as illustrated in FIG. 11D, since the voltage corresponding to the VBAT power supply voltage is applied to the TYPE terminal, the voltage level input to the TYPE_IN terminal becomes approximately “0x03FF”. In this case, although the camera control unit 101 cannot determine the accessory attached to the camera body 100, a current of an unintended voltage level can be prevented from flowing into the TYPE_IN terminal.

On the other hand, in a case where power supply to the VBAT terminal is performed before the accessory type is determined, the A/D conversion is performed on a voltage level input to the TYPE_IN terminal while the power supply voltage indicated by the VBAT terminal is applied to the TYPE terminal. In this case, the voltage level input to the TYPE_IN terminal (after the A/D conversion) becomes approximately “0x03FF”. In this case, since the voltage level input to the TYPE_IN terminal corresponds to error 1 illustrated in Table 1, the camera control unit 101 cannot determine the accessory attached to the camera body 100.

Next, as illustrated in FIG. 11E, in a case where the TYPE terminal is short-circuited to an adjacent terminal due to adhesion of a conductive foreign substance between the TYPE terminal and the adjacent PGND terminal, or the like, a signal line on the PGND terminal side is connected to the TYPE terminal. In this case, the PGND terminal is a ground terminal. Thus, the voltage input to the TYPE_IN terminal is determined based on a ratio (division ratio) between the pull-up resistor (100 kΩ) and the protection resistor (1 kΩ) in the camera body 100, and becomes approximately “0x000A”. Thus, also in this case, the camera control unit 101 cannot determine the accessory attached to the camera body 100.

As described above, in a case where the TYPE terminal is short-circuited to an adjacent terminal, a voltage level input to the TYPE_IN terminal becomes a value close to a voltage level indicated by the PGND terminal, or becomes a value close to a voltage level of the power supply voltage indicated by the VBAT terminal. In such a case, since the camera control unit 101 cannot determine the type of accessory attached to the camera body 100, the camera control unit 101 cannot execute or instruct a proper operation for each accessory.

Accordingly, the camera body 100 according to the present embodiment is controlled such that, in a case where a value near a voltage level indicated by the PGND terminal is input to the TYPE_IN terminal of the camera control unit 101, the camera control unit 101 does not perform communication with the accessory. In the present embodiment, in a case where a voltage level input to the TYPE_IN terminal falls within a range “0x0000 to 0x007F”, the camera control unit 101 determines that the connection state of the TYPE terminal is an error state in which an abnormality has occurred, and does not perform communication with the accessory.

In a case where a value of a power supply voltage level indicated by the VBAT terminal is input to the TYPE_IN terminal, the camera control unit 101 is controlled not to perform communication with the accessory. In the present embodiment, in a case where a voltage level input to the TYPE_IN terminal falls within a range “0x0380 to 0x03FF”, the camera control unit 101 determines that the connection state of the TYPE terminal is an error state in which an abnormality has occurred, and does not perform communication with the accessory.

Due to this configuration, the camera body 100 according to the present embodiment can prevent a voltage level exceeding a rated voltage from being applied to the accessory side while the type of the accessory attached to the camera body 100 is erroneously determined.

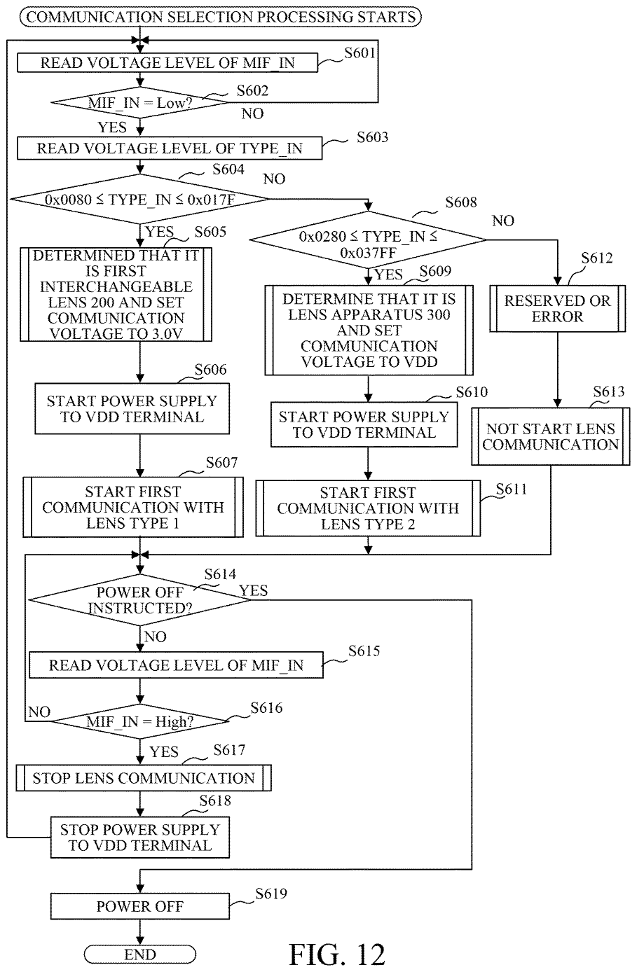

Next, with reference to FIG. 12, communication selection processing indicating processing until the above-described first communication is started will be described as an operation performed when an accessory is attached to the camera body 100. FIG. 12 is a flowchart illustrating, by way of example, an operation until the first communication is started when any accessory is attached to the camera body 100. In the present embodiment, a program corresponding to the flowchart illustrated in FIG. 12 is stored in a memory (not illustrated) provided in the camera control unit 101, and the camera control unit 101 executes the program read from the memory. Therefore, operations in each step described below are performed by the camera control unit 101. A configuration may be adopted in which, instead of operation according to a predetermined program, each unit constituting the camera body 100 and the accessory instructs and executes operations corresponding to respective steps. In the present embodiment, the camera control unit 101 functions as a detector for detecting a voltage level indicated by each terminal and as a control unit for controlling communication via each communication terminal.

First, according to a power-on instruction of the camera body 100 by operation of a power switch (not illustrated) provided in the camera body 100, communication selection processing is started. In step S601, the camera control unit 101 reads a voltage level of an MIF_IN terminal and stores, in a RAM area (not illustrated) in the above-described memory, information on a state of the MIF_IN terminal based on the read voltage level.

Next, in step S602, based on the information on the state of the MIF_IN terminal stored in the RAM area, the camera control unit 101 determines that no accessory is attached to the camera body 100 in a case where the MIF_IN terminal indicates a high voltage level, and the flow returns to step S601. In a case where the MIF_IN terminal indicates a low voltage level, the camera control unit 101 determines that an accessory is attached to the camera body 100.

Next, in step S603, the camera control unit 101 A/D-converts and reads a voltage level input to the TYPE_IN terminal, and stores, in the above RAM area, information on a state of the TYPE_IN terminal based on the read voltage level.

Next, in step S604, the camera control unit 101 determines, as the state of the TYPE_IN terminal read from the RAM area, whether the voltage level input to the TYPE_IN terminal is equal to or higher than “0x0080” and equal to or lower than “0x017F”. In a case where it is determined that the voltage level input to the TYPE_IN terminal is equal to or higher than “0x0080” and equal to or lower than “0x017F”, the flow proceeds to step S605, and in a case where the above condition is not satisfied, the flow proceeds to step S608.

Next, in step S605, the camera control unit 101 determines that the accessory attached to the camera body 100 is the first interchangeable lens 200 (lens type 1), and controls the power supply switching unit 104 to set the power supply Vs for the communication interface to 3.0 V.

Next, in step S606, the camera control unit 101 starts power supply from the camera power supply unit 103 to the VDD terminal.

Next, in step S607, the camera control unit 101 sets a communication voltage of 3.0 V, and starts the first communication using terminals corresponding to the first communication unit. Then, the flow proceeds to step S614.

Next, in step S608, the camera control unit 101 determines, as the state of the TYPE_IN terminal read from the RAM area, whether the voltage level input to the TYPE_IN terminal is equal to or higher than “0x0280” and equal to or lower than “0x037F”. In a case where it is determined that the voltage level input to the TYPE_IN terminal is equal to or higher than “0x0280” and equal to or lower than “0x037F”, the flow proceeds to step S609. In a case where the above condition is not satisfied, the flow proceeds to step S612.

Next, in step S609, the camera control unit 101 determines that the accessory attached to the camera body 100 is the second interchangeable lens 300 (lens type 2) via the conversion adapter 400. The camera control unit 101 then controls the power supply switching unit 104 to set the power supply Vs to VDD (5.0 V).

Next, in step S610, the camera control unit 101 starts power supply from the camera power supply unit 103 to the VDD terminal.

Next, in step S611, the camera control unit 101 sets a communication voltage of 5.0 V, and starts the first communication using terminals corresponding to the first communication unit. Then, the flow proceeds to step S614.

Next, in step S612, the camera control unit 101 determines that the accessory attached to the camera body 100 is an accessory not compatible with the camera body 100 (reserved), or that a predetermined terminal indicates an abnormality (error).

Next, in step S613, the camera control unit 101 does not start communication with the accessory side, and controls respective units of the camera body 100 to execute processing for displaying a warning indication relating to an error or the like on a display unit 15, and the flow proceeds to step S614.

In step S614, the camera control unit 101 determines whether a power-off instruction of the camera body 100 has been issued by operation of a power switch (not illustrated) or the like. In a case where it is determined in step S614 that the power switch off has been instructed, the flow proceeds to step S619, the power of the camera body 100 is turned off, and the communication selection processing ends. In a case where it is determined in step S614 that the power switch off has not been instructed, the flow proceeds to step S615.

In step S615, the camera control unit 101 reads again the voltage level of the MIF_IN terminal and stores, in the above RAM area, information on the state of the MIF_IN terminal based on the read voltage level. In the processing of step S615, the information on the state of the MIF_IN terminal read in step S601 may be updated (overwritten), or may be stored separately in another storage area.

Next, in step S616, the camera control unit 101 determines, based on the information on the state of the MIF_IN terminal stored in the RAM area, whether or not the MIF_IN terminal indicates a high voltage level. In a case where it is determined in step S616 that the MIF_IN terminal indicates a high voltage level, it is determined that the accessory has been detached from the camera body 100, and the flow proceeds to step S617. On the other hand, in a case where it is determined in step S616 that the MIF_IN terminal does not indicate a high voltage level (i.e., indicates a low voltage level), it is determined that the accessory remains attached to the camera body 100, and the flow returns to the processing in step S614.

In step S617, the camera control unit 101 stops communication with the accessory. Then, in step S618, the camera control unit 101 stops power supply from the camera power supply unit 103 to the VDD terminal, and the flow returns to the processing in step S601. Thereafter, the above processing is repeatedly executed.

Although not illustrated in FIG. 12, at a predetermined timing, it is determined whether or not the driving power supply (VBAT) is to be supplied from the camera body 100 side to the accessory using the VBAT terminal, and VBAT supply is performed based on a result of the determination.

Next, each communication executed between the camera body 100 and an accessory attached to the camera body 100 will be described. First, the first communication will be described. As described above, the first communication is one of communication systems performed between the camera body 100 and the accessory attached to the camera body 100. The first communication unit is a communication system of a synchronous or asynchronous (start-stop) communication scheme (clock-synchronous type or an asynchronous type), and is performed using the LCLK terminal, the DCL terminal, and the DLC terminal corresponding to the first communication unit.

In the present embodiment, both the first interchangeable lens 200 and the second interchangeable lens 300 support the first communication. As described above, the communication voltage for the first communication differs between the first interchangeable lens 200 and the second interchangeable lens 300.

The first communication is used, for example, to transmit, to the accessory, a driving command such as driving of a focus lens, driving of a zoom lens, and aperture driving. The accessory that has received the driving command performs an operation according to the driving commands. The first communication is used when the accessory transmits, to the camera body 100, information on a state of the accessory itself (state information), such as a position of the focus lens, a focal length, and an aperture diameter (F-number).

Next, the second communication will be described. As described above, the second communication is one of communication systems performed between the camera body 100 and the first interchangeable lens 200, and is asynchronous communication performed using the DLC2 terminal corresponding to the second communication unit. The second interchangeable lens 300 does not include terminals corresponding to the second communication unit, such as the DLC2 terminal, and thus the second communication is not performed between the camera body 100 and the second interchangeable lens 300.

In the second communication, the first interchangeable lens 200 serves as a communication master, and transmits, to the camera body 100 side, a predetermined amount of optical data including a position of the focus lens, a position of the zoom lens, an F-number, and a state of an image stabilizing lens, etc., in the first interchangeable lens 200. In the second communication, the camera body 100 serves as a communication slave. Types and an order of data to be transmitted from the first interchangeable lens 200 to the camera body 100 are instructed from the camera body 100 side to the first interchangeable lens 200 side by the first communication described above.

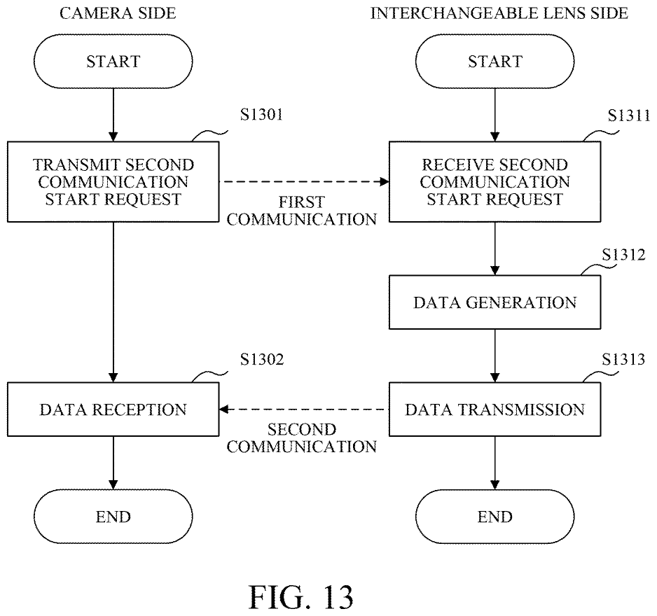

Next, with reference to FIG. 13, operations on the camera side and the accessory side when performing the second communication will be described. FIG. 13 is a flowchart illustrating operations relating to the second communication in the present embodiment. In the present embodiment, a program corresponding to the flowchart illustrated in FIG. 13 is stored in a memory (not illustrated), and the camera control unit 101 and the lens control unit 201 execute the program read from the memory. Therefore, operations in each step described below are performed by the camera control unit 101 or the lens control unit 201. A configuration may be adopted in which, instead of operations according to a predetermined program, respective units constituting the camera body 100 and the first interchangeable lens 200 instruct and execute operations corresponding to the respective steps.

The second communication illustrated in FIG. 13 is started from a timing when imaging control of an object in the camera body 100 is started. First, in step S1301, the camera body 100 transmits, to the first interchangeable lens 200 side, a start request for the second communication by the first communication. The start request transmitted in step S1301 includes a registered communication command in which types of various data intended to be acquired from the first interchangeable lens 200 side by the second communication and an order in which the various data are received are set in advance.

Next, in step S1311, the first interchangeable lens 200 receives the start request transmitted from the camera body 100 side, and the flow proceeds to step S1312. Then, in step S1312, the first interchangeable lens 200 generates various data in a specified order based on the registered communication command included in the start request.

Next, in step S1313, the first interchangeable lens 200 transmits, to the camera body 100 side, the various data generated in the first interchangeable lens 200 by using the second communication. That is, in step S1313, the various data generated by the first interchangeable lens 200 are transmitted toward the camera body 100 side by using the DLC2 terminal 2009 of the first interchangeable lens 200 and the DLC2 terminal 1009 of the camera body 100.

Next, in step S1302, the camera body 100 sequentially receives the various data transmitted from the first interchangeable lens 200 side by using the second communication, and ends the second communication according to completion of reception of each specified data. In the present embodiment, the processing illustrated in FIG. 13 is repeatedly executed each time imaging control of an object is started.

Thus, when executing the second communication, the start request is transmitted using the first communication, while communication of an independent communication system different from the first communication can be performed using terminals corresponding to the second communication unit, which are different from terminals corresponding to the first communication unit. Due to this configuration, between the camera body 100 and the first interchangeable lens 200, various data (e.g., optical data) can be communicated as the second communication without obstructing communication performed in the first communication (e.g., a control request to an actuator). As described above, since the start request for the second communication is transmitted from the camera body 100 side to the first interchangeable lens 200 side using the first communication, the first communication is to be established before the second communication is performed.

Next, the third communication will be described. As described above, the third communication is one of communication systems performed between the camera body 100 and the first interchangeable lens 200, the conversion adapter 400, and the intermediate accessory 500. The third communication is asynchronous communication performed using the DCA terminal and the CS terminal corresponding to the third communication unit. As described above, since the second interchangeable lens 300 does not include terminals corresponding to the third communication unit, the third communication is not performed between the camera body 100 and the second interchangeable lens 300.

In the third communication, the camera body 100 serves as a communication master, and the first interchangeable lens 200, the conversion adapter 400, and the intermediate accessory 500 attached directly or indirectly to the camera body 100 serve as communication slaves.

In the above example, as illustrated in FIGS. 6 and 9, a single conversion adapter 400 or a single intermediate accessory 500 is provided between the camera body 100 and a predetermined interchangeable lens. However, the present disclosure is not limited to this example. For example, two or more of the conversion adapter 400 and the intermediate accessory 500 may be provided between the camera body 100 and the predetermined interchangeable lens. Thus, in the third communication, a plurality of slaves may be connected in series to one master. Thus, in the third communication, it is possible to switch between a broadcast communication mode in which the camera body 100 transmits signals to a plurality of accessories (slaves) at once and a peer-to-peer (P2P) mode in which communication is performed by specifying a particular accessory.

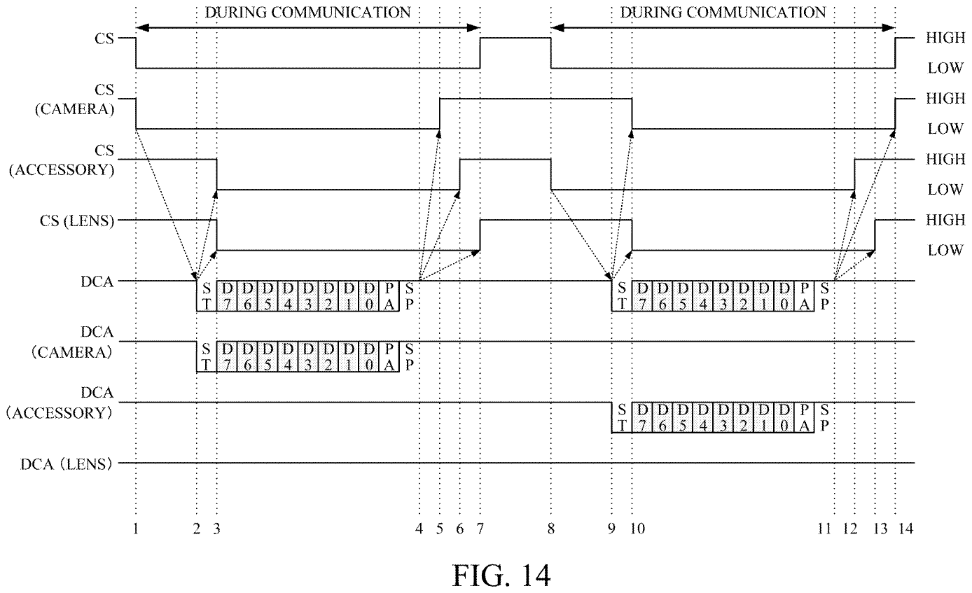

In the broadcast communication mode and the P2P mode in the third communication, the DCA terminal functions as a communication-data terminal enabling bidirectional communication. In contrast, the function of the CS terminal differs between the broadcast communication mode and the P2P mode. Details will now be described. First, the broadcast communication will be described with reference to FIG. 14. FIG. 14 is a timing chart illustrating, by way of example, the broadcast communication in the third communication in the present embodiment. FIG. 14 illustrates a case where the first interchangeable lens 200 is attached to the camera body 100 via the intermediate accessory 500.

In FIG. 14, communication signals using the CS terminal in the broadcast communication of the third communication are indicated as “CS (camera),” “CS (lens),” and “CS (accessory).” Communication signals using the DCA terminal are indicated as “DCA (camera),” “DCA (lens),” and “DCA (accessory).” “CS” and “DCA” in FIG. 14 indicate signal waveforms of respective CS terminals and DCA terminals of the camera body 100, the intermediate accessory 500, and the first interchangeable lens 200 at a predetermined communication control timing. Hereinafter, a case will be described where, according to broadcast communication from the camera control unit 101 to the lens control unit 201 and the accessory control unit 501, the accessory control unit 501 performs broadcast communication to the camera control unit 101 and the lens control unit 201.

In the following description, a signal line connected to the CS terminal will be referred to as a CS signal line, and a signal line connected to the DCA terminal will be referred to as a DCA signal line. At timing 1 in FIG. 14, the camera control unit 101 starts a low output to the CS signal line. This operation is performed to notify the lens control unit 201 and the accessory control unit 501, which are communication slaves, that broadcast communication is to be started, from the camera control unit 101, which is a communication master.

Next, at timing 2 in FIG. 14, the camera control unit 101 outputs data to be transmitted to the DCA signal line. Then, at timing 3 in FIG. 14, the lens control unit 201 and the accessory control unit 501 detect a start bit ST input to the DCA signal line and start a low output to the CS signal line. Since a low output to the CS signal line has already been performed by the camera control unit 101 at timing 1, a signal level of the CS signal line on the camera side does not change at this timing.

Next, when the output of data to a stop bit SP is completed at timing 4 in FIG. 14, at timing 5, the camera control unit 101 releases a low output to the CS signal line. On the other hand, when receiving data up to the stop bit SP, the lens control unit 201 and the accessory control unit 501 analyze the received data and perform internal processing relating to the received data. When the internal processing is completed and preparation for receiving the next data is completed, the lens control unit 201 and the accessory control unit 501 release a low output to the CS signal line at timings 6 and 7 in FIG. 14.

Time for analysis of the received data and internal processing relating to the received data varies depending on processing capability of a CPU included in each control unit. Therefore, to perform continuous communication, each control unit needs to grasp a timing when internal processing relating to the received data is completed in the other control units.

In the present embodiment, as described above, the CS terminal performs an open-drain type output. Thus, a signal level of the CS signal line becomes high when all of the camera control unit 101, the lens control unit 201, and the accessory control unit 501 release a low output to the CS signal line. That is, each control unit (CPU) involved in broadcast communication determines that the other control units (CPUs) are ready for the next communication by confirming that the signal level of the CS signal line has become high. Due to this configuration, the camera body 100 and predetermined accessories of the present embodiment can perform proper continuous communication.

Next, at timing 8 in FIG. 14, the accessory control unit 501 confirms the trailing edge of the CS signal line (i.e., that the CS signal line is high). Thereafter, to notify the camera control unit 101 and the lens control unit 201 of the start of broadcast communication, the accessory control unit 501 starts a low output to the CS signal line.

Next, at timing 9 in FIG. 14, the accessory control unit 501 outputs data to be transmitted to the DCA signal line.

On the other hand, the camera control unit 101 and the lens control unit 201 detect the start bit ST input from the DCA signal line, and start a low output to the CS signal line at timing 10 in FIG. 14. Since the low output to the CS signal line has already been performed by the accessory control unit 501 at timing 8, a signal level of the CS signal line on the accessory side does not change at this timing.

Next, after finishing outputting up to the stop bit SP at timing 11 in FIG. 14, the accessory control unit 501 releases a low output to the CS signal line at timing 12. On the other hand, the camera control unit 101 and the lens control unit 201 receive data up to the stop bit SP input from the DCA signal line. Thereafter, the camera control unit 101 and the lens control unit 201 analyze the received data and perform internal processing associated with the received data, and then release a low output to the CS signal line at timings 13 and 14 when preparation for receiving the next data is completed.

As described above, in the broadcast communication mode of the third communication in the present embodiment, the CS signal line functions as a signal line for notifying a signal indicating the start of broadcast communication and indicating that communication (processing) is in progress.

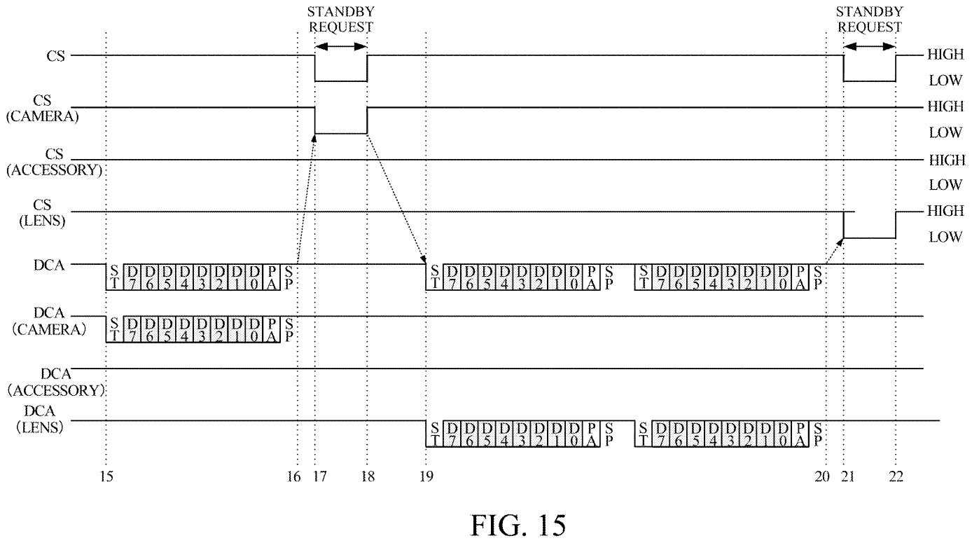

Next, with reference to FIG. 15, a function of the CS terminal in the P2P mode in the third communication will be described. FIG. 15 is a timing chart illustrating, by way of example, the P2P communication in the third communication in the present embodiment. FIG. 15 illustrates a case where the first interchangeable lens 200 is attached to the camera body 100 via the intermediate accessory 500. Signal lines and signal waveforms illustrated in FIG. 15 are approximately the same as those in the broadcast communication mode described with reference to FIG. 14, and thus a description thereof will be omitted.

Hereinafter, a case will be described where the camera control unit 101 transmits one byte of data to the lens control unit 201, and in response to the one byte of data, the lens control unit 201 transmits two bytes of data to the camera control unit 101.

In the following description, a signal line connected to the CS terminal is referred to as a CS signal line, and a signal line connected to the DCA terminal is referred to as a DCA signal line. At timing 15 in FIG. 15, the camera control unit 101 transmits, to the lens control unit 201, an instruction for causing transmission of specific data using the DCA signal line.

Next, after completion of output up to the stop bit SP on the camera-side DCA signal line at timing 16 in FIG. 15, at timing 17, the camera control unit 101 starts a low output to the CS signal line. While outputting a low level signal to the CS signal line, the camera control unit 101 prepares to receive data, and releases a low output to the CS signal line at timing 18 when the preparation is completed.

On the other hand, after detecting the low signal on the CS signal line output by the camera control unit 101, the lens control unit 201 analyzes the instruction received from the camera control unit 101 and performs internal processing relating to the instruction. Thereafter, after confirming that a low output to the CS signal line on the camera side has been released, at timing 19 in FIG. 15, the lens control unit 201 transmits, using the DCA signal line, data corresponding to the instruction received from the camera control unit 101.

Next, after finishing output up to the stop bit SP of the second byte at timing 20 in FIG. 15, at timing 21, the lens control unit 201 starts a low output to the lens-side CS signal line. Thereafter, after preparation for receiving the next data is completed, the lens control unit 201 releases a low output to the CS signal line at timing 22 in FIG. 15. In the description of FIG. 15, the accessory control unit 501 that is not selected as a P2P communication partner does not participate in operations on the CS signal line and the DCA signal line.

As described above, in the P2P mode of the third communication in the present embodiment, the CS signal line functions as a signal line for notifying transmission completion on the transmission side and notifying a standby request relating to data transmission.

As described above, in the third communication in the present embodiment, the functions of the CS terminal differ between the broadcast communication mode and the P2P mode. Due to this configuration, both the broadcast communication mode and the P2P mode can be achieved using only two signal lines, i.e., the CS signal line and the DCA signal line corresponding to the CS terminal and the DCA terminal.

The transmission and reception of various data using the third communication is performed using the DCA terminal having a CMOS output type. Due to this configuration, even in a case where an output type of the CS terminal is an open-drain type, high-speed communication can be achieved.

Based on the circuit configurations and operations of the camera body 100 and respective accessories described above, details of arrangements of terminals arranged in the camera mount A and the lens mount B according to the present embodiment will be described below.

First, the arrangement of the MIF terminals will be described. Here, assume a case where the MIF terminal 1005 of the camera-side mount is disposed at a position where the MIF terminal 1005 slides on terminals (contact surfaces) other than the MIF terminal 2005 disposed in the lens mount B, or a case where the connection completion of the MIF terminals precedes that of the DGND terminals or the PGND terminals. In such a case, while the lens mount B is not completely attached to the camera mount A, power is not supplied from the camera body 100 side to the accessory side. Thus, when terminals provided in the lens mount B slide on terminals provided in the camera mount A side, the MIF terminal 1005 may contact a terminal other than the MIF terminal 2005, and a voltage level indicated by the MIF terminal 1005 may momentarily become low.

In this case, although the connection completion between corresponding terminals of both mounts has not been achieved, the camera body 100 side may erroneously detect that the accessory is attached. Therefore, power supply may be started while the accessory is not completely attached to the camera body 100, and power supply and ground connection may be electrically unstable, possibly causing malfunction or the like of the camera body 100 and the accessory. This problem similarly occurs in a case where the connection of the MIF terminals is established before the connection of the ground terminals.

To address the above problems, in the present embodiment, the MIF terminals 1005 and 2005 in the camera mount A and the lens mount B are arranged on a rear side in the lens attachment direction in the lower stage of the camera mount and in the middle stage of the lens mount, respectively. For example, during the attachment and detachment of the mounts, the MIF terminal 1005 on the camera mount A side is disposed at a position where it does not slide on any terminal other than the MIF terminal 2005 on the lens mount B side, and contact pressure between the MIF terminals is configured to be lower than that of other terminals. This configuration can prevent erroneous detection of the attachment of the accessory on the camera body 100 side. Due to this configuration, power is supplied from the camera body 100 side to the accessory side while power-system terminals and ground terminals are reliably connected. Thus, the camera body 100 and each accessory of the present embodiment can reduce malfunctions or the like of the camera body 100 and the accessory.

Next, the arrangement of the DLC terminal, the DCL terminal, and the LCLK terminal corresponding to the first communication unit will be described. As described above, driving control and acquisition of state information between the camera body 100 and the first interchangeable lens 200 and the second interchangeable lens 300 are performed using the first communication. In other words, the transmission and reception of main data necessary for imaging operation using the camera body 100 is performed using the first communication. Even if terminals corresponding to the second communication unit and the third communication unit are worn due to sliding between terminals and electrical connection between such terminals becomes unstable, major driving control of the accessory relating to imaging operation is possible as long as the first communication is accurately performed. Therefore, terminals corresponding to the first communication unit are more important terminals for performing imaging operation than terminals corresponding to the second and third communication units.

Accordingly, in the camera mount A of the present embodiment, the terminals corresponding to the first communication unit are arranged at positions where the number of slides (the number of contacts) between terminals is smaller than that of terminals corresponding to the second and third communication units. More specifically, in the camera mount A of the present embodiment, the DLC terminal, the DCL terminal, and the LCLK terminal corresponding to the first communication unit are arranged further on a rear side (farther) in the lens attachment direction than the DLC2 terminal, the CS terminal, and the DCA terminal. In the camera mount A, the DLC terminal, the DCL terminal, and the LCLK terminal corresponding to the first communication unit are arranged at positions where the number of slides (the number of contacts) between terminals is smaller next to the MIF terminal. Therefore, the arrangement of the terminals in the lens mount B is positioned reversely relative to the arrangement of the terminals in the camera mount A.

Due to this configuration, the durability against the slides (contacts) between terminals according to the increased number of attachments and detachments of the accessory to/from the camera body 100 can be made higher for the terminals corresponding to the first communication unit than for terminals corresponding to the second and third communication units. Thus, the camera body 100 and the accessory of the present embodiment can suppress communication failure caused by friction between contact pins and contact surfaces corresponding to the DCL terminal, the DLC terminal, and the LCLK terminal corresponding to the first communication unit, and can improve communication reliability between them.

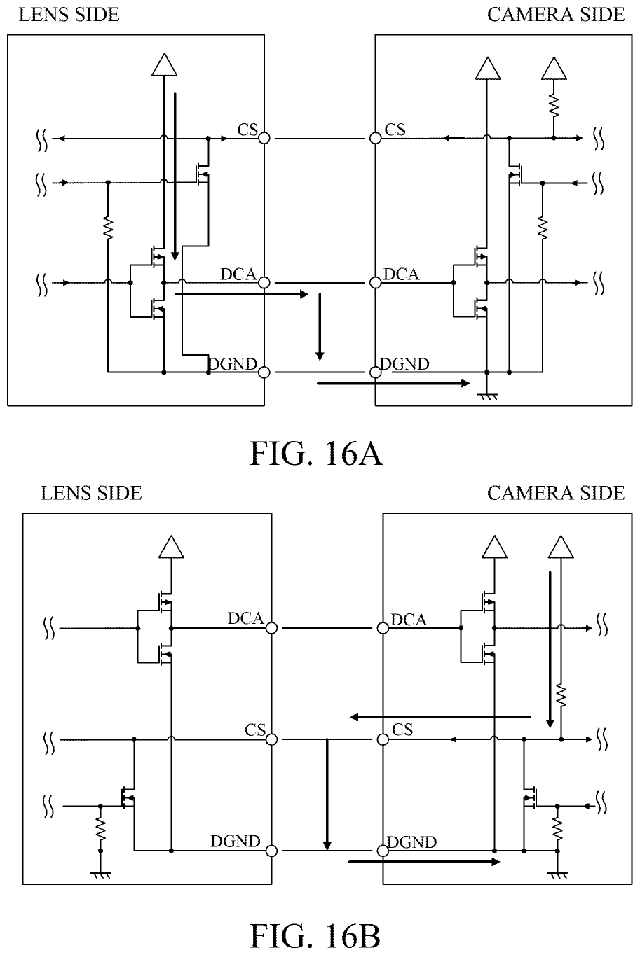

Next, with reference to FIGS. 16A and 16B, the arrangements of the DGND terminal and the CS terminal will be described. FIGS. 16A and 16B are diagrams illustrating, by way of example, the internal configurations of the CS terminal, the DCA terminal, and the DGND terminal in the camera mount A and the lens mount B according to a comparative example and the present embodiment. FIG. 16A illustrates a comparative example in which, unlike the terminal arrangement order described in the present embodiment, the DCA terminal is disposed adjacent to the DGND terminal. FIG. 16B illustrates the terminal arrangement order in the present embodiment.

As described above, the DCA terminal is a CMOS output type terminal. Thus, as illustrated in FIG. 16A, in a case where short-circuiting occurs between the DCA terminal and the DGND terminal, a relatively large current flows in a direction indicated by an arrow in FIG. 16A. More specifically, when a voltage level indicated by the DCA terminal is set to a high output while a conductive foreign matter or the like adheres between the DCA terminal and the DGND terminal, the DCA terminal of the CMOS output type is short-circuited to the DGND terminal. In this case, an unintended large current may flow toward the DGND terminal on the camera side along the path indicated by the arrow in FIG. 16A. As a result, a malfunction or the like may occur in an electric circuit of the camera body 100.

In contrast, in the present embodiment, as illustrated in FIG. 16B, the DGND terminal is disposed adjacent to the CS terminal. As described above, the CS terminal is a terminal that performs the open-type output. Therefore, even when short-circuiting occurs between the DGND terminal and the CS terminal due to, for example, adhesion of a conductive foreign matter or the like between the DGND terminal and the CS terminal, only a minute current flows toward the DGND terminal side along the path indicated by the arrow in FIG. 16B. More specifically, since the CS terminal is a terminal that performs the open-type output, even when the DGND terminal and the CS terminal are short-circuited, only a minute current having a low voltage level flows toward the DGND terminal on the camera side from the camera-side power supply through a pull-up resistor. Therefore, by adopting the above configuration, the camera body 100 and the accessory according to the present embodiment can prevent malfunction or the like in the electric circuit of the camera body 100 that would otherwise be caused by a large current flowing to the ground side via the camera-side DGND terminal.

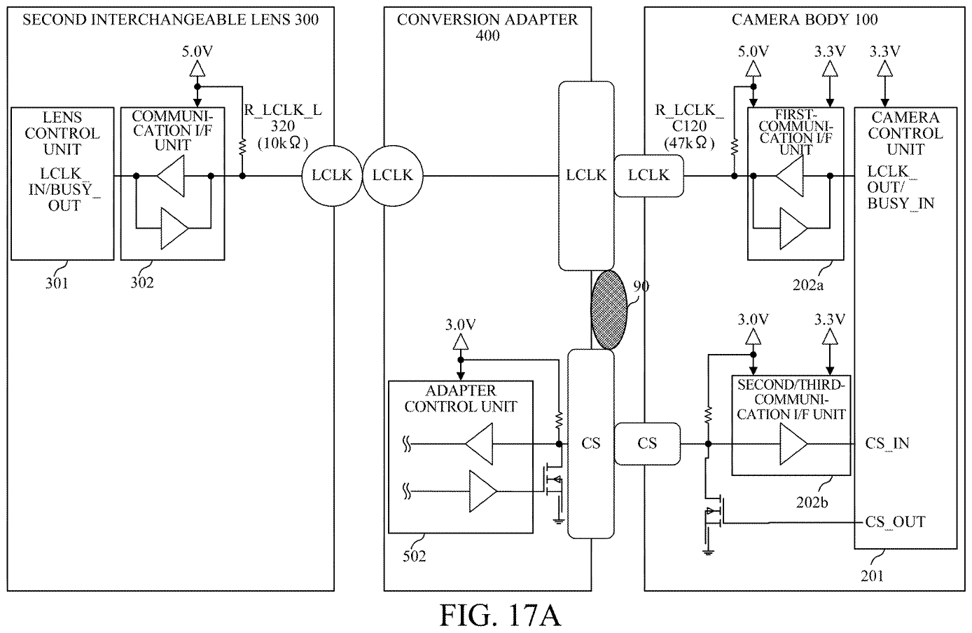

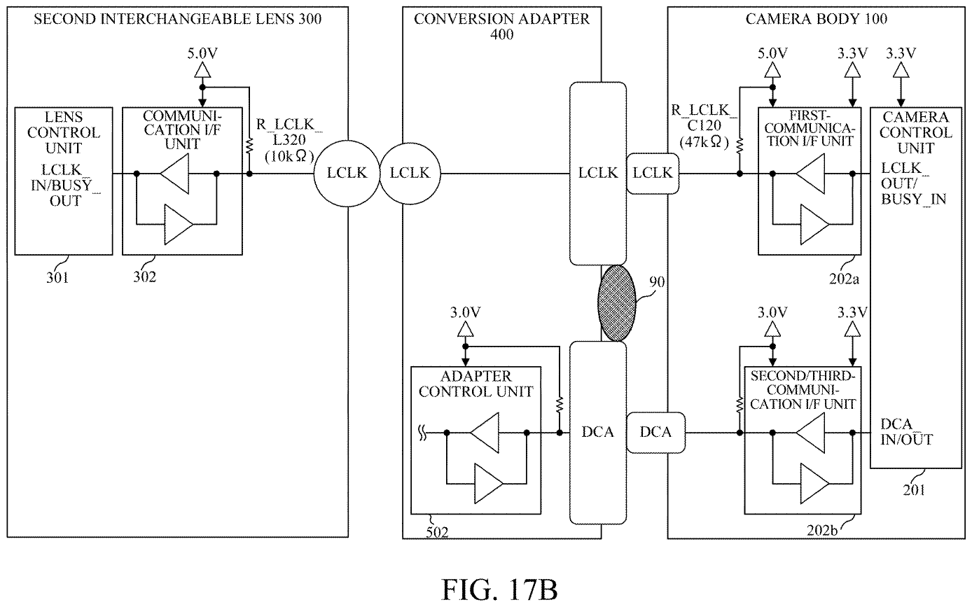

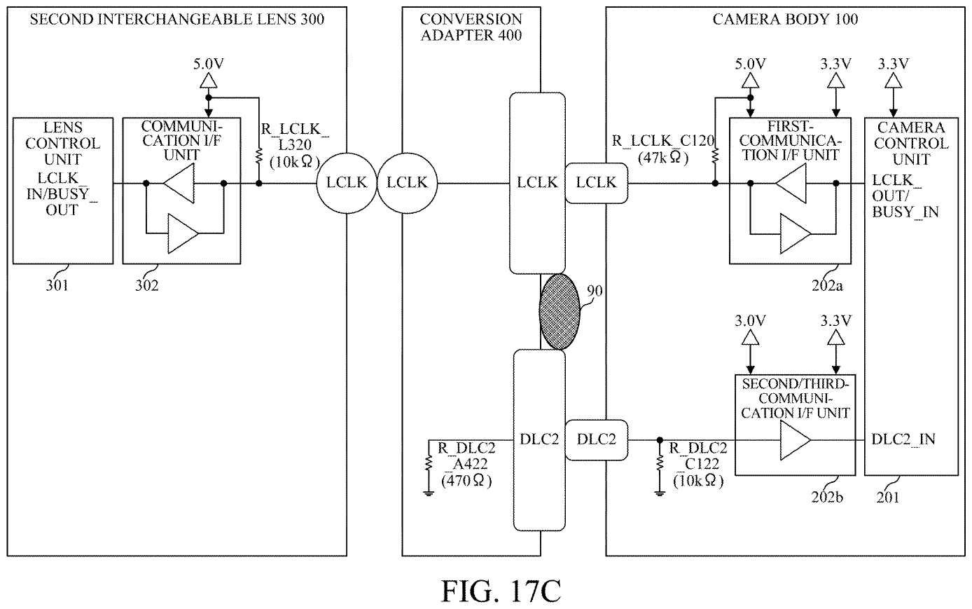

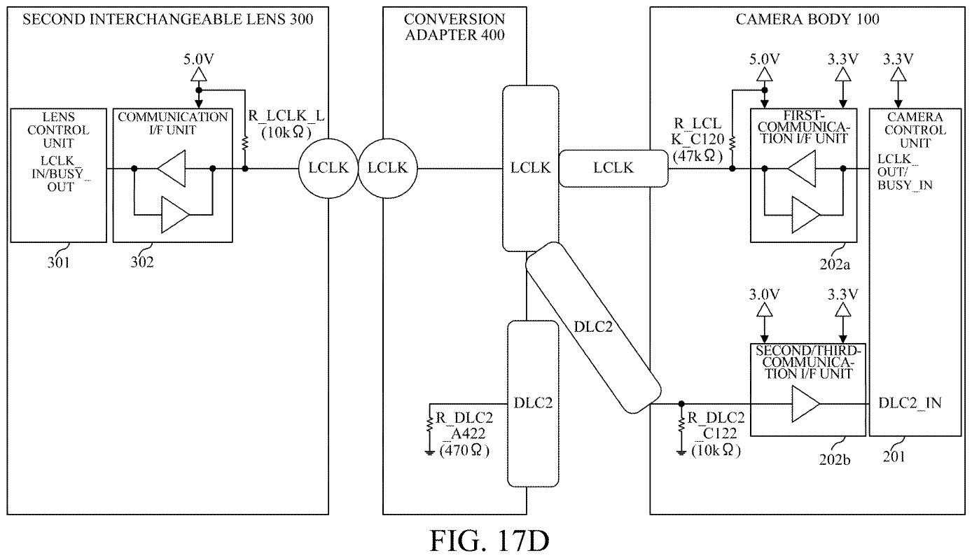

Next, with reference to FIGS. 17A, 17B, 17C, and 17D, the arrangement of the DLC2 terminal and the LCLK terminal will be described. FIGS. 17A, 17B, 17C, and 17D are diagrams illustrating, by way of example, the influences on an electric circuit according to a difference in terminals arranged adjacent to the LCLK terminal in the present embodiment. FIG. 17A illustrates a case where the CS terminal is disposed adjacent to the LCLK terminal. FIG. 17B illustrates a case where the DCA terminal is disposed adjacent to the LCLK terminal. FIG. 17C illustrates a case where a foreign matter exists between the LCLK terminal and the DLC2 terminal when the DLC2 terminal is disposed adjacent to the LCLK terminal. FIG. 17D illustrates a case where a bent terminal contacts an adjacent terminal when the DLC2 terminal is disposed adjacent to the LCLK terminal. FIGS. 17A, 17B, 17C, and 17D illustrate a case where the second interchangeable lens 300 is attached to the camera body 100 via the conversion adapter 400.

As illustrated in FIG. 17A, assume, for example, a case where the CS terminal is disposed adjacent to the LCLK terminal in the camera body 100 and the conversion adapter 400. In FIG. 17A, a conductive foreign matter 90 exists between the LCLK terminal and the CS terminal of the conversion adapter 400, and conduction between the two terminals causes short-circuiting between the terminals.

Assume a case where the second interchangeable lens 300 is attached to the camera body 100 via the conversion adapter 400. In this case, as illustrated, a signal line of the LCLK terminal is pull-up connected to VDD (5.0 V) via a resistor R_LCLK_C120 in the camera body 100 and a resistor R_LCLK_L320 in the second interchangeable lens 300. On the other hand, assume that the CS terminal is pull-up connected to a voltage level of 3.0 V via a resistor (resistor element) provided inside the camera body 100 and a resistor (resistor element) provided inside the conversion adapter 400.

In this case, due to the short-circuiting between the LCLK terminal and the CS terminal, a voltage of 3.0 V or higher is applied from the signal line side of the LCLK terminal to the signal line side of the CS terminal via the resistors R_LCLK_C120 and R_LCLK_L320. Normally, both the second/third-communication I/F unit 102b and the adapter control unit 401 operate with a power supply voltage of 3.0 V. However, as described above, in a case where the two terminals are short-circuited, a voltage higher than an upper limit voltage is applied to elements such as the second/third-communication I/F unit 102b and the adapter control unit 401, and thus a malfunction or the like may occur in electric circuits of the conversion adapter 400 and the camera body 100.

Here, the upper limit voltage is a rated voltage, i.e., a voltage at which malfunction or the like does not occur in the electric circuit connected to each terminal. Alternatively, the upper limit voltage is an operating voltage, i.e., a voltage at which the electric circuit connected to each terminal can normally operate.

Next, as illustrated in FIG. 17B, assume, for example, a case where, in the camera body 100 and the conversion adapter 400, the DCA terminal is disposed adjacent to the LCLK terminal. In FIG. 17B, a conductive foreign matter 90 exists between the LCLK terminal and the DCA terminal of the conversion adapter 400, and conduction between the two terminals causes short-circuiting between the terminals.

Assume a case where the second interchangeable lens 300 is attached to the camera body 100 via the conversion adapter 400. In this case, as illustrated, the signal line of the LCLK terminal is pull-up connected to VDD (5.0 V) via the resistor R_LCLK_C120 in the camera body 100 and the resistor R_LCLK_L320 in the second interchangeable lens 300. On the other hand, assume that the DCA terminal is pull-up connected to a voltage level of 3.0 V via a resistor (resistor element) provided inside the camera body 100 and a resistor (resistor element) provided inside the conversion adapter 400.

In this case, due to the short-circuiting between the LCLK terminal and the DCA terminal, a voltage of 3.0 V or higher is applied from the signal line side of the LCLK terminal to the signal line side of the DCA terminal via the resistors R_LCLK_C120 and R_LCLK_L320. Normally, both the second/third-communication I/F unit 102b and the adapter control unit 401 operate with a power supply voltage of 3.0 V. However, as described above, in a case where the two terminals are short-circuited, a voltage higher than the upper limit voltage is applied to elements such as the second/third-communication I/F unit 102b and the adapter control unit 401, and thus a malfunction or the like may occur in electric circuits of the conversion adapter 400 and the camera body 100.

For the reasons described above, the CS terminal and the DCA terminal may not be set as terminals corresponding to the second and third communication units adjacent to the LCLK terminal corresponding to the first communication unit on the front side in the lens attachment direction.

Hereinafter, the DLC2 terminal is disposed adjacent to the LCLK terminal as a configuration of the present embodiment. As illustrated in FIG. 17C, assume a case where the LCLK terminal and the DLC2 terminal are arranged adjacent to each other and short-circuiting occurs between the terminals due to presence of the conductive foreign matter 90. In this case, as described above, since the second interchangeable lens 300 does not include a terminal (DLC2 terminal) corresponding to the second communication unit, the second communication is not performed even if the second interchangeable lens 300 is attached to the camera body 100 via the conversion adapter 400. That is, in a case where the second interchangeable lens 300 is attached to the camera body 100 via the conversion adapter 400, the DLC2 terminal corresponding to the second communication unit is not used between the camera body 100 and the second interchangeable lens 300.

Therefore, in a case where the second interchangeable lens 300 is attached to the camera body 100 via the conversion adapter 400, even if the LCLK terminal and the DLC2 terminal are short-circuited, a malfunction or the like does not occur in the electric circuit of the conversion adapter 400 such as the adapter control unit 401. Even if the LCLK terminal and the DLC2 terminal are short-circuited, voltages applied to the two terminals can be suppressed to be equal to or lower than respective upper limit voltages by resistance division based on resistors provided in the second interchangeable lens 300, the conversion adapter 400, and the camera body 100. Details thereof will be described later. That is, a terminal corresponding to the second communication unit (DLC2 terminal) may be disposed adjacent to a terminal corresponding to the first communication unit. Due to this configuration, the camera body 100 and the conversion adapter 400 in the present embodiment can prevent malfunction or the like in respective electric circuits of the conversion adapter 400 and the camera body 100.

In a case where the first interchangeable lens 200 is attached to the camera body 100, the communication voltages of the first communication unit and the second communication unit are the same (3.0 V). In this case, even if the LCLK terminal and the DLC2 terminal are short-circuited, a voltage higher than the upper limit voltage is not applied to elements such as the I/F unit 102 of the camera body 100, as described above.

In a case where the first interchangeable lens 200 is attached to the camera body 100, there may be a case where the second communication and the third communication are used independently and simultaneously. In this case, even if the DLC2 terminal corresponding to the second communication unit is short-circuited to the DCA terminal corresponding to the third communication unit, no voltage higher than the operating voltage is applied to the second/third-communication I/F unit 102b because the communication voltages of the second communication unit and the third communication unit are the same (3.0 V).

As described above, the DLC2 terminal corresponding to the second communication unit may be disposed adjacent to a terminal corresponding to the first communication unit, and a terminal corresponding to the third communication unit (CS terminal or DCA terminal) may be disposed on the opposite side of the DLC2 terminal. That is, a terminal corresponding to the third communication unit may be disposed adjacent to the DLC2 terminal on the opposite side of the DLC2 terminal from the LCLK terminal corresponding to the first communication unit, with the DLC2 terminal corresponding to the second communication unit interposed therebetween. Due to this configuration, regardless of which interchangeable lens is attached directly or indirectly to the camera body 100, malfunction or the like in electric circuits of the camera body 100 and the conversion adapter 400 can be prevented.

Here, voltages applied to respective interface units inside the camera body 100 will be described in detail. In a case where the second interchangeable lens 300 is attached to the camera body 100 via the conversion adapter 400, the signal line of the LCLK terminal is pull-up connected to VDD (5.0 V) via the resistor R_LCLK_C120 in the camera body 100 and the resistor R_LCLK_L320 in the second interchangeable lens 300. On the other hand, the DLC2 terminal is pull-down connected to the signal line of the DGND terminal via a resistor R_DLC2_C122 provided inside the camera body 100 and a resistor R_DLC2_A422 provided inside the conversion adapter 400.

Let a combined resistance of R_LCLK_C120 and R_LCLK_L320 be R_LCLK, and let a combined resistance of R_DLC2_C122 and R_DLC2_A422 be R_DLC2. As described above, in a case where short-circuiting between terminals occurs, let a voltage applied to the signal lines of the LCLK terminal and the DLC2 terminal be V_ST1. The combined resistance R_LCLK, the combined resistance R_DLC2, and the applied voltage V_ST1 are calculated by the following equations (1), (2), and (3), respectively:

R_LCLK=1/((1/R_LCLK_C120)+(1/R_LCLK_L320))(1)

R_DLC2=1/((1/R_DLC2_C122)+(1/R_DLC2_A422))(2)

V_ST1=5.0×(R_DLC2/(R_LCLK+R_DLC2))(3)

For example, in a case where R_LCLK is set to 10 kΩ2 and R_DLC2 is set to 100 kΩ, the applied voltage V_ST1 becomes approximately 4.5 V based on equations (1), (2), and (3), and thus a voltage exceeding the upper limit voltage (3.0 V) of the second/third-communication I/F unit 102b is applied.

Accordingly, in the present embodiment, for example, by setting R_LCLK to 10Ω and R_DLC2 to 10Ω, the applied voltage V_ST1=2.5 V is adjusted to be equal to or lower than the upper limit voltage (3.0 V) of the second/third-communication I/F unit 102b. To make the applied voltage equal to or lower than the upper limit voltage of the second/third-communication I/F unit 102b, the following equation (4) may be satisfied:

(R_DLC2/(R_LCLK+R_DLC2))≤(3.0/VDD) (4)

Setting resistance values of R_LCLK_C120, R_LCLK_L320, R_DLC2_C122, and R_DLC2_A422 so as to satisfy equation (4) described above can protect the second/third-communication I/F unit 102b from overvoltage.

In the present embodiment, as described above, the camera control unit 101 detects that the LCLK terminal has switched from a low level to a high level just after a predetermined interchangeable lens is attached. In a case where the interchangeable lens is the second interchangeable lens 300, the camera control unit 101 performs communication with the second interchangeable lens 300 using the open-drain output type, and determines, through the communication, whether the second interchangeable lens 300 supports the CMOS output type communication. Then, in a case where it is determined that the second interchangeable lens 300 supports the CMOS output type communication, the output scheme of the LCLK terminal and the DCL terminal is switched to the CMOS output type. Here, in a case where the output types of the LCLK terminal and the DCL terminal are switched to the CMOS output type, the voltage indicated by the LCLK terminal 1008 becomes a power supply voltage (5.0 V) output from the first-communication I/F unit 102a without passing through R_LCLK_C120.

Assume that a low-level input threshold (VIL_LCLK) of the LCLK signal input terminal of the first-communication I/F unit 102a is 0.5 V, and that R_LCLK=10 kΩ, R_DLC2_A422=470Ω, and R_DLC2_C122=10 kΩ. In this case, based on equations (2) and (3), since an applied voltage V_ST1≈V is lower than the low-level input threshold of the first-communication I/F unit 102a, the camera control unit 101 determines that communication with the interchangeable lens is not possible, and controls so as not to start communication with the lens side.

Due to this configuration, on the camera body 100 side, the output type of the LCLK terminal is not switched to the CMOS output type, and thus it is possible to prevent a voltage exceeding an upper limit voltage from being applied to elements such as the second/third-communication I/F unit 102b. To prevent the output type of the LCLK terminal from being switched to the CMOS output type on the camera body 100 side, the following equation (5) may be satisfied:

(R_DLC2/(R_LCLK+R_DLC2))≤VIL_LCLK (5)

Setting the resistance values of R_LCLK_C120, R_LCLK_L320, R_DLC2_C122, and R_DLC2_A422 so as to satisfy equation (5) can protect the second/third-communication I/F unit 102b from overvoltage.

However, even in a case where equation (5) is satisfied, if the resistance value of R_DLC2_C122 is small, a terminal current of the lens-side I/F unit 202 is to be set to a large value during second communication using the DLC2 terminal. For example, a case where R_DLC2_A422 is 10 kΩ and R_DLC2_C122 is 470Ω corresponds to this situation. In contrast, the present embodiment, considering the second communication, sets the resistance values such that R_DLC2_A422=470Ω is smaller than R_DLC2_C122=10 kΩ.

Next, as illustrated in FIG. 17D, assume that the LCLK terminal and the DLC2 terminal are arranged adjacent to each other, and the contact pin of the DLC2 terminal 1009 provided on the camera body 100 side is bent and short-circuited to the adjacent LCLK terminal. Terminal processing of the LCLK terminal and the DLC2 terminal is as described above, and thus a description thereof will be omitted.

In the case illustrated in FIG. 17D, let a voltage applied to the LCLK terminal and the DLC2 terminal 1009 on the camera body 100 side be V_ST2. Then, the applied voltage V_ST2 is calculated by equation (6):

V_ST2=5.0×R_DLC2_C122/(R_LCLK+R_DLC2_C122) (6)

For example, if R_LCLK is 10 kΩ and R_DLC2_C122 is 100 kΩ, V_ST2 becomes approximately 4.5 V based on equations (1) and (6), and thus a voltage exceeding the upper limit voltage (3.0 V) of the second/third-communication I/F unit 102b is applied. In this case, as described above, a malfunction or the like may occur in an electric circuit of the camera body 100 including the second/third-communication I/F unit 102b.

Therefore, in the present embodiment, for example, by setting R_LCLK=10Ω and R_DLC2_C122=10 kΩ, the applied voltage V_ST2=2.5 V is adjusted to be equal to or lower than the upper limit voltage (3.0 V) of the second/third-communication I/F unit 102b. For the applied voltage to be equal to or lower than the upper limit voltage of the second/third-communication I/F unit 102b, the following equation (7) may be satisfied. A high-level input threshold of a DLC2 signal input terminal of the second/third-communication I/F unit 102b will be referred to as VIH_DLC2.

VIH_DLC2≤R_DLC2/(R_LCLK+R_DLC2)≤(3.0/VDD) (7)

Setting the resistance values of R_LCLK_C120, R_LCLK_L320, and R_DLC2_C122 so as to satisfy equation (7) described above can protect the second/third-communication I/F unit 102b from overvoltage.

Here, in a case where the second interchangeable lens 300 is attached to the camera body 100 via the conversion adapter 400, the DLC2 terminal is pull-down connected to the DGND signal line via a resistor (resistor element) R_DLC2_A422 provided inside the conversion adapter 400. In this case, a low-level voltage is expected to be input to a DLC2 input terminal (DLC2_IN) provided in the camera control unit 101.

Assume that the high-level input threshold VIH_DLC2 of the DLC2 signal input terminal is 2.3 V, and that R_LCLK is 10 kΩ and R_DLC2_C122 is 10 kΩ. Then, since the applied voltage V_ST2=2.5 V exceeds the threshold voltage level of VIH_DLC2 based on equation (6), the camera control unit 101 determines that the DLC2 terminal outputs a high-level voltage. Hence, a high-level voltage, rather than the expected low-level voltage, is input to the DLC2 input terminal (DLC2_IN), and thus it is possible to detect that an abnormality exists in the terminal in this case (error detection). In this case, the LCLK terminal 1008 remains in the open-drain output state, and an alert display prompting the user to check the states of the terminals provided in each mount is presented (error processing).

Due to this configuration, even when the LCLK terminal and the DLC2 terminal are short-circuited due to bending/breakage of a terminal, the LCLK terminal 1008 of the camera body 100 is not switched to a CMOS output type terminal, and the second/third-communication I/F unit 102b can be protected from overvoltage.

If the communication voltages of the second and third communication units are also configured to be switched according to the attached interchangeable lens so as to be the same as the voltage of the first communication unit, it becomes possible to prevent malfunction or the like in an electric circuit when short-circuiting between terminals occurs. However, in order to reduce power consumption for communication and to increase communication speed, the communication voltages of the second and third communication units are set to match the lowest voltage among communication voltages of the first communication unit.

FIG. 19 is an exploded perspective view illustrating an example of the mount portions of the camera body 100 and an accessory in the present embodiment. Here, the first interchangeable lens 200 is illustrated as an example of the accessory, but the present embodiment is also applicable to other accessories. A camera mount 161 is fixed to a housing 165 of the camera body 100 by four screws 166 via a mount biasing member 167. The mount biasing member 167 is a member that generates a biasing force that pulls bayonet claws, which will be described later, of a lens mount 261 toward the camera mount side. A camera terminal unit 168 is fixed to the housing 165 so as to be positioned on an inner side of the camera mount 161.

The housing 165 holds a lock pin 163 as a protrusion movably between a protruding position where the lock pin 163 protrudes from a mount surface (camera mount surface) of the camera mount 161 toward the object side (lens side), and a retracted position where the lock pin 163 is retracted further toward the image side. The lock pin 163 is biased by a spring toward the protruding position. The camera mount 161 includes three bayonet claws at intervals in a circumferential direction. When detaching the first interchangeable lens 200 from the camera body 100, a user pushes in a release operation member 164 provided on the camera body 100 to move the lock pin 163 from the protruding position to the retracted position.

On the other hand, the lens mount 261 is fixed to a lens barrel 264 serving as a housing of the first interchangeable lens 200 by four screws 263. The lens mount 261 has a mount surface (lens mount surface), and three bayonet claws as coupling portions at intervals in the circumferential direction.

A lens terminal unit (a second terminal portion and a terminal holder) 265 is fixed to an inner circumferential portion of the lens mount 261 by a plurality of screws 266.

In the present embodiment, a mount apparatus (accessory mount) includes the lens mount 261, the lens terminal unit 265, the four screws 263, and the plurality of screws 266. The second mount portion corresponds to the lens mount 261, and bayonet claws and conductive members are provided in the second mount portion.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

For example, in each embodiment, a digital camera is adopted as an example of the camera body 100, which is an image pickup apparatus; however, an image pickup apparatus other than a digital camera, such as a digital video camera or a security camera, may also be used.

Also, in each embodiment, as an example of the accessory, an interchangeable lens, a conversion adapter, or an intermediate accessory is employed; however, the present disclosure is not limited to this example. For example, as the accessory, any device other than those described above may be employed as long as the device can be directly and/or indirectly coupled (attached) to the camera mount A of the camera body 100.

In each embodiment, as illustrated in FIGS. 4A and 4B, a direction in which the lens mount B is rotated clockwise relative to the camera mount A, when viewed from the object side during imaging, is defined as an attachment direction; however, the present disclosure is not limited to this example. For example, a direction in which the lens mount B is rotated counterclockwise relative to the camera mount A, when viewed from the object side during image capturing, may be defined as the attachment direction. In this case, at least the arrangement of the terminals arranged on each of the mounts described above may be reversed.

In the present embodiment, the lens attachment direction (accessory attachment direction) is defined based on the camera mount A, and the arrangement of the terminals in each mount has been described; however, in a case where the lens mount B is used as the reference, the arrangement relationship of the terminals is reversed. For example, in a case where the lens mount B is used as the reference, the VDD terminal 2001 first comes into contact with one of the terminals arranged on the camera mount A. Thus, a side on which the VDD terminal 2001 is arranged is regarded as a front side in the lens attachment direction. Alternatively, the arrangement of the terminals may be defined based on a relative attachment direction (rotation direction) between the camera mount A and the lens mount B. In this case, among the terminals of the camera mount A, a side on which the VDD terminal that comes into contact with the terminal provided on the lens mount B last is arranged is the rear side; and among the terminals of the lens mount B, a side on which the VDD terminal that comes into contact with the terminal provided on the camera mount A first is arranged is the front side. Among the terminals of the camera mount A, a side on which the DGND terminal that comes into contact with the terminal provided on the lens mount B first is arranged is the front side; and among the terminals of the lens mount B, a side on which the DGND terminal that comes into contact with the terminal provided on the camera mount A last is arranged is the rear side.

The rearmost side and the frontmost side in the lens attachment direction described above indicate positions within a range in which terminals corresponding to both the camera mount and the lens mount exist while the accessory is attached to the camera body 100. Therefore, for example, in a mount of an accessory mountable on the camera body 100, in a case where a terminal not provided on the camera body 100 side exists, the position at which such a terminal is arranged is not limited. In a case where an image pickup apparatus to which each accessory described in the above embodiments is attached has a terminal not provided on the accessory side, the position at which such a terminal is disposed is not limited.

In each embodiment, the terminals provided on the mount on the image pickup apparatus side are contact pins and the terminals provided on the mount on the accessory side are contact surfaces; however, the present disclosure is not limited to this example. For example, contact surfaces may be provided on the mount on the image pickup apparatus side, and contact pins corresponding to the contact surfaces may be provided on the mount on the accessory side, such that the corresponding contact surfaces and contact pins are electrically connectable. In this case, the characteristics of the camera mount and the accessory mount described in the above embodiments can also be implemented in the corresponding accessory mount and the lens mount.

In the image pickup apparatus and the accessory according to each embodiment, for example, in a case where the terminals provided on the camera mount are configured as contact surfaces, a width in the circumferential direction of each contact surface on the mount may be properly adjusted. In a case where the terminals provided on the accessory mount are configured as contact pins, a pitch between the contact pins provided on the accessory mount may be properly adjusted.

In each embodiment, a computer program that follows the flows illustrated in FIGS. 12 and 13 is stored in advance in a memory (not illustrated) and the camera control unit 101 executes the program; however, the present disclosure is not limited to this example. For example, as long as that program has the functions of a computer program, the form of the program is not limited, such as object code, a program executed by an interpreter, or script data supplied to an OS. A recording medium corresponding to a memory for supplying the program can use, for example, a magnetic recording medium such as a hard disk drive or a magnetic tape, and an optical/optical-magnetic recording medium.

In the present embodiment, the camera mount A and the lens mount (accessory mount) B are bayonet-coupled by actually rotating an apparatus that includes one of the mounts relative to an apparatus that includes the other mount. However, the present disclosure is not limited to this example. For example, a configuration may be employed in which the camera mount A and the lens mount B are rotated relative to each other so as to enable bayonet coupling between them.

As described above, the accessory mount (200, 300, 400, 500) of the present embodiment is attachable to and detachable from the camera mount, and includes a second terminal portion (terminals 2001 to 2012) and a terminal holder (contact-surface holding member 205) that holds the second terminal portion. The second terminal portion contacts a first terminal portion (terminals 1001 to 1012) of the camera mount while the accessory mount is attached to the camera mount. The terminal holder includes a first step 251 and a second step 252 having different heights in an optical axis direction. The second terminal portion includes a first terminal (terminal 2005), a second terminal (terminal 2006), and a third terminal (terminal 2004), each having a different tip height in the optical axis direction. The first terminal is used to detect that the accessory mount is attached to the camera mount.

The terminal holder may further include a third step 253. The third step may be positioned between the first step and the second step in the optical axis direction, and the first terminal may be disposed on the third step. Only the first terminal among a plurality of terminals may be disposed on the third step. That is, the first terminal is disposed on the third step, and none of the second terminal and the third terminal is disposed on the third step. The second terminal may be disposed on the first step. The third terminal may be disposed on the second step.

The first terminal may be disposed adjacent, in a circumferential direction when viewed from the central axis direction, to each of the second terminal and the third terminal.

The second terminal may be used to communicate with an apparatus (camera body 100) including the camera mount. Here, the apparatus including the camera mount is not limited to an image pickup apparatus (camera body 100), and may be a connection apparatus for performing lens firmware update by connecting to a PC, a measurement apparatus for measuring optical characteristics of the lens, an adapter, an extender, an extension tube, or the like.

The third terminal may be used to be grounded to the ground level. The third terminal may be used to determine a type of an apparatus including the accessory mount.

The second terminal may be disposed on the first step and used to communicate with the apparatus including the camera mount, and the third terminal may be disposed on the second step and used to determine the type of the apparatus including the accessory mount.

In the attachment of the accessory mount to the camera mount, the first terminal may come into contact with a plurality of terminals of the camera mount. For example, in the attachment of the accessory mount to the camera mount, the first terminal may come into contact with at least one other terminal on the second step, or may come into contact with all other terminals on the second step.

The accessory may include the accessory mount and an optical element. Here, the accessory is a lens apparatus (interchangeable lens), an adapter, an extender, or the like. The optical element includes, for example, a lens, an optical filter (an ND filter, an IR cut filter, an apodization filter, or the like), a reflective element (a mirror, a prism), and a transmissive reflective element (PBS (polarization beam splitter), a transmissive reflective lens, a transmissive reflective mirror, or the like).

The accessory may include an accessory mount and be attachable to and detachable from the lens apparatus. Here, the mount may be detachable from the lens apparatus, and a mount (mount member) attachable to the lens apparatus by screwing or the like is also included as an accessory (a type of adapter).

According to each embodiment, an accessory mount in an accessory apparatus includes a properly configured terminal portion that comes into contact with the camera mount. By increasing a distance between some terminals of the camera mount and the accessory mount (weakening contact between some terminals), each embodiment can suppress wear due to friction between terminals and deterioration of electrical characteristics. Each embodiment is effective for countermeasures against short-circuiting between adjacent terminals.

This application claims the benefit of Japanese Patent Application No. 2025-074299, filed on Apr. 28, 2025, which is hereby incorporated by reference herein in its entirety.

What is claimed is:

1. An accessory mount attachable to and detachable from a camera mount that includes a first terminal portion, the accessory mount comprising:
a second terminal portion configured to contact the first terminal portion while the accessory mount is attached to the camera mount; and
a terminal holder that holds the second terminal portion,
wherein the terminal holder includes a first step and a second step having different heights in a central axis direction,
wherein the second terminal portion includes a first terminal, a second terminal, and a third terminal that have different tip heights in the central axis direction, and
wherein the first terminal is configured to be used to detect that the accessory mount is attached to the camera mount.

2. The accessory mount according to claim 1, wherein the terminal holder includes a third step having a height different from that of each of the first step and the second step.

3. The accessory mount according to claim 2, wherein among a plurality of terminals included in the second terminal portion, no terminal other than the first terminal is disposed on the third step.

4. The accessory mount according to claim 3, wherein among a plurality of terminals included in the second terminal portion, the first terminal is disposed on the third step, and none of the second terminal and the third terminal is disposed on the third step.

5. The accessory mount according to claim 3, wherein the second terminal is disposed on the first step.

6. The accessory mount according to claim 3, wherein the third terminal is disposed on the second step.

7. The accessory mount according to claim 3, wherein the following inequality is satisfied:
0.0<D13/D12<0.8
where D12 is a distance between the first step and the second step in the central axis direction, and D13 is a distance between the first step and the third step in the central axis direction.

8. The accessory mount according to claim 1, wherein, when viewed in the central axis direction, the first terminal is disposed adjacent to each of the second terminal and the third terminal in a circumferential direction.

9. The accessory mount according to claim 1, wherein the second terminal is used to perform communication with an apparatus that includes the camera mount.

10. The accessory mount according to claim 1, wherein the third terminal is a ground terminal.

11. The accessory mount according to claim 1, wherein the third terminal is used to determine a type of an apparatus that includes the accessory mount.

12. The accessory mount according to claim 3, wherein the second terminal is disposed on the first step and is used to perform communication with an apparatus that includes the camera mount, and
wherein the third terminal is disposed on the second step and is used to determine a type of an apparatus that includes the accessory mount.

13. The accessory mount according to claim 1, wherein, when the accessory mount is attached to the camera mount, the first terminal is configured to contact a plurality of terminals of the camera mount.

14. An accessory comprising:
the accessory mount according to claim 1; and
an optical element.

15. An accessory comprising:
the accessory mount according to claim 1,
wherein the accessory is attachable to and detachable from a lens apparatus.
